(19) United States
(12) Patent Application Publication
(10) Pub. No.: US 2026/0208516 A1
(43) Pub. Date: Jul. 23, 2026

(54) INKJET PRINTER

(71) Applicant: MIMAKI ENGINEERING CO., LTD., Nagano (JP)

(72) Inventors: Kohei Suzuki, Nagano (JP); Kaito Mishima, Nagano (JP); Toshihiro Kimura, Nagano (JP); Masayuki Furuse, Nagano (JP)

(73) Assignee: MIMAKI ENGINEERING CO., LTD., Nagano (JP)

(21) Appl. No.: 19/139,361

(22) PCT Filed: Feb. 14, 2024
(86) PCT No.: PCT/JP2024/004945

§ 371 Date: Jun. 15, 2025

(30) Foreign Application Priority Data
Feb. 16, 2023 (JP) 2023-022695
Feb. 16, 2023 (JP) 2023-022696
Dec. 21, 2023 (JP) 2023-215472

(51) Int. Cl. B41J 29/02; B41J 11/00; B41J 11/08; B41J 25/00

(52) U.S. Cl. CPC B41J 29/02; B41J 11/0085; B41J 11/08; B41J 25/005

(57) ABSTRACT

An inkjet printer includes a platen on which a medium is placed, a main body frame configured to support the platen from a lower side, and supporting legs to which the main body frame is fixed. The main body frame includes a fixed portion formed in a flat plate shape elongated in a Y direction, which is a width direction of the medium, and fixed on the supporting legs, and a main frame portion elongated in the Y direction and formed in a groove steel shape in which both sides and a lower side in the Y direction are opened. The width of the fixed portion in an X direction orthogonal to an up-down direction and the Y direction is wider than a width of the main frame portion in the X direction, and the main frame portion is fixed to an upper surface of the fixed portion.

### TECHNICAL FIELD The present invention relates to an inkjet printer configured to perform printing on a medium by ejecting ink.

### BACKGROUND ART

Conventionally, an inkjet printer configured to perform printing on a medium by ejecting ink is known (see, e.g., Patent Literature 1). The inkjet printer described in Patent Literature 1 includes a supporting base, and a guiding portion and a main body portion supported by the supporting base. The supporting base includes supporting legs and two base plates. The supporting leg includes two leg portions and a coupling plate that couples the two leg portions. The leg portion includes a foot portion, a supporting column, an arm portion, and a top plate.

In the inkjet printer described in Patent Literature 1, the main body portion includes a main body case, a base portion that supports the main body case, and two coupling members fixed to the base portion. The base portion has a columnar appearance and extends along a main scanning direction that is the width direction of the medium. In the inkjet printer described in Patent Literature 1, the main body portion is fixed to the supporting base by fixing the coupling member to the top plate of the leg portion. The guiding portion includes a platen on which the medium at the time of printing is placed. The platen is supported from the lower side by the base portion.

Furthermore, conventionally, an inkjet printer configured to perform printing on a medium by ejecting ink is known (see, e.g., Patent Literature 2). The inkjet printer described in Patent Literature 2 includes an inkjet head configured to eject ink toward a medium, a carriage on which the inkjet head is mounted, a carriage driving mechanism configured to move the carriage in a main scanning direction, and a Y rail configured to hold the carriage so as to be movable in the main scanning direction. The Y rail functions as a guide when the carriage moves in the main scanning direction.

In the inkjet printer described in Patent Literature 2, the carriage is attached to the Y rail by way of an attachment structure. The attachment structure is attached to both end portions of the carriage in the main scanning direction. The attachment structure includes a plurality of guide rollers (bearings) that roll in contact with the Y rail, and a support base to which the plurality of guide rollers are rotatably attached. The support base is fixed to the carriage. In the inkjet printer described in Patent Literature 2, the carriage is guided in the main scanning direction by the plurality of guide rollers and the Y rail.

### CITATION LIST

### Patent Literature

Patent Literature 1: Japanese Unexamined Patent Publication No. 2016-49721

Patent Literature 1: Japanese Unexamined Patent Publication No. 2014-221540

### SUMMARY OF INVENTION

### Problems to be Solved by Invention

The inventor of the present application has developed an inkjet printer including a platen on which a medium at the time of printing is placed, a main body frame for supporting the platen from the lower side, and a plurality of supporting legs (leg portions) to which the main body frame is fixed at upper end portions, like the inkjet printer described in Patent Literature 1. In this inkjet printer, since the main body frame fixed to the upper end portions of the plurality of supporting legs needs to support various components constituting the inkjet printer from the lower side, the strength of the main body frame is preferably high. Furthermore, in this inkjet printer, the weight of the main body frame is preferably reduced in order to reduce the weight of the inkjet printer.

Therefore, an object of the present invention is to provide an inkjet printer including a platen on which a medium at the time of printing is placed, a main body frame for supporting the platen from the lower side, and a plurality of supporting legs to which the main body frame is fixed at upper end portions, the inkjet printer capable of reducing the weight of the main body frame while increasing the strength of the main body frame.

Furthermore, the inventor of the present application has developed an inkjet printer including an inkjet head configured to eject ink toward a medium, a carriage on which the inkjet head is mounted, a carriage driving mechanism configured to move the carriage in a main scanning direction, and a carriage holding member configured to hold the carriage so as to be movable in the main scanning direction, like the inkjet printer described in Patent Literature 2. In an inkjet printer under development, a carriage includes a carriage main body to which an inkjet head is attached, and a plurality of guide rollers turnably attached to the carriage main body.

In addition, in the inkjet printer under development, the carriage holding member is formed with a guide rail on which a contact surface with which the guide roller comes into contact is formed. In this inkjet printer, a carriage moving in the main scanning direction is guided by the plurality of guide rollers and the guide rail. In the development process of such an inkjet printer, it has become apparent from the study of the inventors of the present application that periodic vibration occurs in the carriage moving in the main scanning direction.

Therefore, an object of the present invention is to provide an inkjet printer in which a carriage moving in a main scanning direction is guided by a plurality of guide rollers included in the carriage and a guide rail formed on a carriage holding member configured to hold the carriage so as to be movable in the main scanning direction, the inkjet printer capable of suppressing periodic vibration of the carriage moving in the main scanning direction.

### Means for Solving Problems

In order to solve the above problems, an inkjet printer of the present invention relates to an inkjet printer configured to perform printing on a medium by ejecting ink, the inkjet printer including an inkjet head configured to eject ink toward the medium, a platen on which the medium at the time of printing is placed, a main body frame that supports the platen from a lower side, and a plurality of supporting legs to which the main body frame is fixed at an upper end portion; wherein when a reciprocating direction of the inkjet head is referred to as a main scanning direction, the main body frame includes a first frame having a fixed portion formed in a flat plate shape elongated in the main scanning direction and placed and fixed on the plurality of supporting legs, and a second frame having a main frame portion formed in an elongated shape elongated in the main scanning direction and formed in a groove steel shape in which both sides and a lower side in the main scanning direction are opened; and
when a direction orthogonal to an up-down direction and the main scanning direction is referred to as a first direction, a width of the fixed portion in the first direction is wider than a width of the main frame portion in the first direction, the main frame portion is fixed to an upper surface of the fixed portion, and the platen is disposed on an upper side of the main frame portion.

In the inkjet printer of the present invention, the main body frame includes a first frame having a fixed portion formed in a flat plate shape elongated in the main scanning direction and placed and fixed on the plurality of supporting legs, and a second frame having a main frame portion formed in an elongated shape elongated in the main scanning direction and formed in a groove steel shape in which both sides and a lower side in the main scanning direction are opened. Furthermore, in the present invention, a width of the fixed portion in the first direction is wider than a width of the main frame portion in the first direction, and the main frame portion is fixed to an upper surface of the fixed portion.

That is, in the present invention, the fixed portion of the first frame and the main frame portion of the second frame fixed to the upper surface of the fixed portion form a quadrangular tubular structural portion elongated in the main scanning direction on the main body frame, and the quadrangular tubular structural portion elongated in the main scanning direction may be the main portion of the main body frame. Therefore, in the present invention, the weight of the main body frame can be reduced while increasing the strength of the main body frame.

In the present invention, the first frame preferably includes flat plate-shaped side surface portions rising toward an upper side from both ends of the fixed portion in the first direction. With this configuration, the strength of the first frame can be increased as compared with a case where the first frame is configured only by the flat plate-shaped fixed portion. Therefore, the strength of the main body frame can be further increased.

In the present invention, preferably, the inkjet printer further includes two of the supporting legs, wherein a length of the fixed portion in the main scanning direction is longer than a length of the main frame portion in the main scanning direction, the two supporting legs are disposed on the outer side than the main frame portion in the main scanning direction, the second frame includes a reinforcing portion extending from the main frame portion to at least an upper side of the supporting leg toward the outer side in the main scanning direction, and the reinforcing portion is fixed to an upper surface of the fixed portion. With this configuration, even if the two supporting legs are disposed on the outer side than the main frame portion in the main scanning direction, the strength of the upper side portion of the supporting leg of the main body frame serving as the fulcrum of the main body frame supported by the two supporting legs can be increased. Therefore, deformation of the main body frame when a load acts on the main body frame can be suppressed.

Furthermore, in order to solve the above problems, an inkjet printer of the present invention relates to an inkjet printer configured to perform printing on a medium by ejecting ink from an inkjet head, the inkjet printer including a platen on which the medium at the time of printing is placed, a main body frame that supports the platen from a lower side, and a plurality of supporting legs to which the main body frame is fixed at an upper end portion; wherein when a reciprocating direction of the inkjet head is referred to as a main scanning direction, the main body frame includes a first frame and a second frame formed in an elongated shape elongated in the main scanning direction, when a direction orthogonal to an up-down direction and the main scanning direction is referred to as a first direction, the second frame includes a main frame portion formed in an elongated shape elongated in the main scanning direction and formed in a groove steel shape in which both sides and a lower side in the main scanning direction are opened, and a flat plate-shaped bottom surface portion extending from a lower end of the main frame portion toward an outer side in the first direction, the first frame includes a second main frame portion formed in an elongated shape elongated in the main scanning direction and formed in a groove steel shape in which both sides and an upper side in the main scanning direction are opened. the second main frame portion includes a fixed portion formed in a flat plate shape elongated in the main scanning direction and placed and fixed to the plurality of supporting legs, and flat plate-shaped side surface portions rising toward an upper side from both ends in the first direction of the fixed portion, a width of the second main frame portion in the first direction is wider than a width of the main frame portion in the first direction, the bottom surface portion is fixed to upper end sides of the side surface portions, and the platen is disposed on an upper side of the main frame portion.

In the inkjet printer of the present invention, the second frame constituting a part of the main body frame includes a main frame portion formed in an elongated shape elongated in the main scanning direction and formed in a groove steel shape in which both sides and a lower side in the main scanning direction are opened, and a flat plate-shaped bottom surface portion extending from a lower end of the main frame portion toward an outer side in the first direction. Furthermore, in the present invention, the first frame constituting a part of the main body frame includes the second main frame portion formed in an elongated shape elongated in the main scanning direction and formed in a groove steel shape in which both sides and an upper side in the main scanning direction are opened. Furthermore, in the present invention, the width of the second main frame portion in the first direction is wider than the width of the main frame portion in the first direction, and the bottom surface portion of the second frame is fixed to the upper end side of the side surface portion of the second main frame portion.

That is, in the present invention, the first frame and the second frame form a tubular structural portion whose outer shape when viewed from the main scanning direction is a convex shape (shape obtained by up-down inverting a substantially T-shape) and which is elongated in the main scanning direction in the main body frame, where this tubular structural portion elongated in the main scanning direction is a main portion of the main body frame. Therefore, in the present invention, the weight of the main body frame can be reduced while increasing the strength of the main body frame.

In the present invention, it is preferable that the first frame includes a flat plate-shaped upper surface portion extending toward an inner side in the first direction from an upper end of the side surface portion, and the bottom surface portion is fixed to the upper surface portion in a state of being placed on the upper surface portion. With this configuration, the fixed state of the bottom surface portion fixed to the upper end side of the side surface portion can be stabilized. Therefore, the strength of the main body frame can be further increased. Moreover, according to such a configuration, the bottom surface portion in the state of being placed on the upper surface portion merely needs to be fixed to the upper surface portion, so that the fixing work of the bottom surface portion can be easily performed.

In the present invention, the inkjet printer preferably includes a reinforcing member that closes the opening of the second main frame portion formed on both sides in the main scanning direction. With this configuration, the strength of the main body frame on both end sides in the main scanning direction can be increased.

In the present invention, an inkjet printer includes, for example, a transportation roller configured to transport a medium in the first direction, and a roller supporting portion configured to rotatably support the transportation roller, and the roller supporting portion is attached to the main frame portion. In the inkjet printer of the present invention, the strength of the main body frame can be increased. Therefore, even if the roller supporting portion that supports the transportation roller receiving the reaction force from the medium at the time of transportation or the like is fixed to the main frame portion, the transportation roller can be appropriately supported by the main body frame by way of the roller supporting portion.

In the present invention, preferably, the inkjet printer includes a platen supporting portion formed or fixed to the second frame and to which the platen is fixed, a plurality of suction holes for sucking the medium at the time of printing is formed in the platen, a space to which the plurality of suction holes communicate is formed between the upper surface of the main frame portion and the lower surface of the platen, and a fan for discharging air from the space is attached to the main frame portion. With this configuration, the air from the space can be discharged to the inner side of the main frame portion formed in the groove steel shape using the fan attached to the main frame portion. Therefore, the medium at the time of printing can be sucked and fixed to the platen with a relatively simple configuration.

In the present invention, the platen supporting portion is preferably formed separately from the second frame and fixed to the second frame. Since the second frame is formed in an elongated shape elongated in the main scanning direction, when the platen supporting portion is formed in the second frame, handling of the second frame when forming the platen supporting portion becomes complicated, and the manufacturing cost of the second frame in which the platen supporting portion is integrally formed may increase. On the other hand, even if the second frame is formed in an elongated shape elongated in the main scanning direction, handling of the second frame when fixing the platen supporting portion formed separately to the second frame is relatively easy, and hence with such a configuration, the manufacturing cost of the second frame in a state where the platen supporting portion is fixed can be reduced.

In the present invention, preferably, the inkjet printer includes a carriage on which the inkjet head is mounted, a carriage driving mechanism configured to move the carriage in the main scanning direction, and a maintenance unit that prevents clogging of a plurality of nozzles formed on a lower surface of the inkjet head, wherein a length of the first frame in the main scanning direction is longer than a length of the main frame portion in the main scanning direction, and the maintenance unit is disposed on one side of the main frame portion in the main scanning direction, and is attached to an upper surface side of the first frame.

With this configuration, even if the height of the maintenance unit is high, the upper surface of the maintenance unit can be disposed at an appropriate position with respect to the upper surface of the platen by adjusting the height of the main frame portion. Furthermore, the position of the upper surface of the platen is set to a position where a predetermined gap is formed between the upper surface of the platen and the lower surface of the inkjet head. Therefore, even if the height of the maintenance unit is high, the upper surface of the maintenance unit can be disposed at an appropriate position with respect to the lower surface of the inkjet head.

In the present invention, preferably, the inkjet printer further includes a carriage on which the inkjet head is mounted, a carriage driving mechanism configured to move the carriage in the main scanning direction, a carriage holding member formed in an elongated shape elongated in the main scanning direction and configured to hold the carriage so as to be movable in the main scanning direction, two side plates that are fixed with both end portions of the carriage holding member in the main scanning direction and that are fixed to the main body frame, and two second side plates that are disposed on both sides of the main frame portion in the main scanning direction and that are fixed to the main body frame, wherein the two second side plates are disposed on an inner side of the two side plates in the main scanning direction, and the carriage holding member is fixed to the two side plates and the two second side plates. With such a configuration, since the carriage holding member is fixed to the two second side plates in addition to the two side plates, deformation such as deflection of the carriage holding member when a load acts on the carriage holding member formed in an elongated shape elongated in the main scanning direction can be effectively suppressed.

In the present invention, when one side in the first direction is a front side and the other side in the first direction is a back side, for example, the inkjet head mounted on the carriage is disposed on the front side of the carriage holding member, the first fixing surface and the second fixing surface to which the carriage holding member is fixed are formed on the second side plate, the first fixing surface is a plane orthogonal to the up-down direction, the second fixing surface is a plane orthogonal to the first direction, and is disposed on the back side and the upper side of the first fixing surface, the front lower end portion of the carriage holding member is fixed to the first fixing surface, and the back lower end portion of the carriage holding member is fixed to the second fixing surface.

In the present invention, the first frame preferably includes flat plate-shaped side surface portions rising toward an upper side from both ends of the fixed portion in the first direction, and the second side is preferably fixed to the upper end sides of the two side surface portions. With this configuration, the second side plate can prevent the two side surface portions from opening toward the outer side in the first direction. Therefore, the strength of the first frame can be increased.

In order to solve the above problems, the inventors of the present application conducted various studies. As a result, the inventor of the present application has found that there is a relationship between the period of vibration generated in the carriage when moving in the main scanning direction and the rotation cycle of the guide roller (time during which the guide roller makes one rotation). Furthermore, in the inkjet printer under development, the outer diameters of the plurality of guide rollers included in the carriage all have the same size and the rotation cycles of all the guide rollers coincide, but the inventor of the present application has conducted further study and found that it is possible to suppress the periodic vibration of the carriage moving in the main scanning direction by including the guide rollers having different outer diameters in the plurality of guide rollers included in the carriage (i.e., by including guide rollers having different rotation cycles in the plurality of guide rollers).

An inkjet printer of the present invention is based on such a new finding, and includes an inkjet head configured to eject ink toward a medium, a carriage on which the inkjet head is mounted, a carriage driving mechanism configured to move the carriage in a main scanning direction that is a reciprocating direction of the inkjet head, and a carriage holding member formed in an elongated shape elongated in the main scanning direction and configured to hold the carriage to be movable in the main scanning direction, wherein the carriage includes a carriage main body to which the inkjet head is attached, and a plurality of guide rollers configured to guide the carriage in the main scanning direction, the plurality of guide rollers are rotatably attached to the carriage main body, a guide rail, on which a contact surface with which the guide roller comes into contact is formed, is formed in the carriage holding member, and an outer diameter of at least one guide roller among the plurality of guide rollers is different from outer diameters of the remaining guide rollers excluding the guide roller.

In the inkjet printer of the present invention, the outer diameter of at least one guide roller among the plurality of guide rollers is different from the outer diameters of the remaining guide rollers excluding the guide roller. That is, in the present invention, the guide rollers having different outer diameters are included in the plurality of guide rollers included in the carriage. Therefore, in the present invention, the periodic vibration of the carriage moving in the main scanning direction can be suppressed.

In the present invention, for example, the carriage includes a guide roller group including a plurality of the guide rollers, when one side in a sub-scanning direction orthogonal to an up-down direction and the main scanning direction is referred to as a front side and other side in the sub-scanning direction is referred to as a back side, the carriage main body is disposed on a front side of the carriage holding member, the guide roller group includes a first guide roller and a second guide roller serving as the guide rollers attached to an upper end side of the carriage main body and a third guide roller and a fourth guide roller serving as the guide rollers attached to a lower end side of the carriage main body, and is attached to a back end portion of each of both end sides of the carriage main body in the main scanning direction, and the carriage holding member is formed with a first guide rail serving as the guide rail on which a first contact surface serving as the contact surface with which the first guide roller comes into contact from the front side and a second contact surface serving as the contact surface with which the second guide roller comes into contact from an obliquely backward upper side, and a second guide rail serving as the guide rail on which a third contact surface serving as the contact surface with which the third guide roller comes into contact from the front side and a fourth contact surface serving as the contact surface with which the fourth guide roller comes into contact from an obliquely backward lower side.

In the present invention, the outer diameter of at least one of the first guide roller and the second guide roller is preferably larger than the outer diameters of the remaining guide rollers. According to the study of the inventors of the present application, in the carriage moving in the main scanning direction, the vibration on the upper end side of the carriage tends to be larger than the vibration on the lower end side of the carriage, but when the outer diameter of at least one of the first guide roller and the second guide roller attached to the upper end side of the carriage main body is larger than the outer diameter of the remaining guide roller, the periodic vibration of the carriage moving in the main scanning direction can be effectively suppressed.

In the present invention, the carriage preferably includes two types of guide rollers having different outer diameters. With this configuration, as compared with a case where the carriage includes three or more types of guide rollers having different outer diameters, component management of the guide rollers becomes easy, and an error in attachment of the guide rollers when assembling the carriage can be suppressed.

### Effect of the Invention

Therefore, according to the present invention, in an inkjet printer including a platen on which a medium at the time of printing is placed, a main body frame configured to support the platen from the lower side, and a plurality of supporting legs to which the main body frame is fixed at upper end portions, the weight of the main body frame can be reduced while increasing the strength of the main body frame.

Furthermore, according to the present invention, in an inkjet printer in which a carriage moving in a main scanning direction is guided by a plurality of guide rollers included in the carriage and a guide rail formed on a carriage holding member configured to hold the carriage so as to be movable in the main scanning direction, periodic vibration of the carriage moving in the main scanning direction can be suppressed.

### BRIEF DESCRIPTION OF THE DRAWINGS

FIG. 1 is a perspective view of an inkjet printer according to an embodiment of the present invention.

FIG. 2 is a perspective view illustrating a platen, a main body frame, an upper end portion of a supporting leg, and a second side plate illustrated in FIG. 1 in an extracted manner.

FIG. 3 is an enlarged view describing a configuration of portion E of FIG. 1.

FIG. 4 is a side view illustrating a carriage holding member, a medium transporting mechanism, a platen, a main body frame, and a second side plate from an F-F direction in FIG. 3.

FIG. 5 is an enlarged view of portion G in FIG. 2.

FIG. 6 is a cross-sectional view of H-H cross section in FIG. 2.

FIG. 7 is an enlarged view of portion J in FIG. 4.

FIG. 8 is an enlarged view of portion K in FIG. 4 in a state where a second side plate is removed.

FIG. 9 is a side view illustrating an inkjet head, a carriage, and a carriage holding member illustrated in FIG. 1 in an extracted manner.

FIG. 10 is a rear perspective view illustrating a guide roller and a roller holding member illustrated in FIG. 9 in an extracted manner.

FIG. 11 is a side view illustrating a guide rail and the guide roller illustrated in FIG. 9 in an extracted manner.

FIG. 12 is a perspective view for explaining a configuration of a main body frame according to another embodiment of the present invention.

FIG. 13 is an enlarged view of portion N in FIG. 12.

FIG. 14 is a cross-sectional view for explaining the configuration of the main body frame illustrated in FIG. 12.

### EMBODIMENTS FOR IMPLEMENTING INVENTION

Hereinafter, embodiments of the present invention will be described with reference to the drawings.

### Overall Configuration of Inkjet Printer

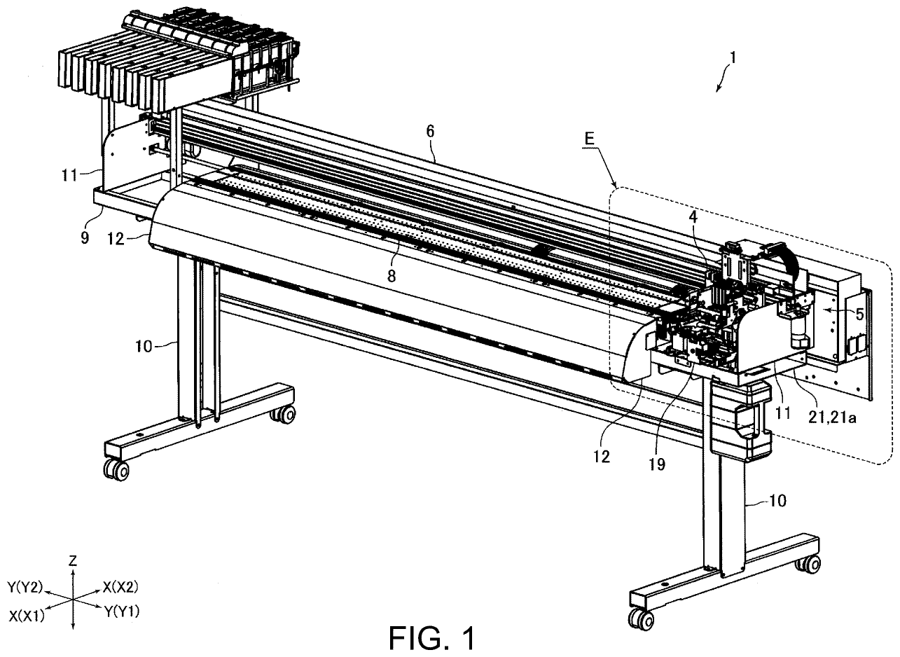

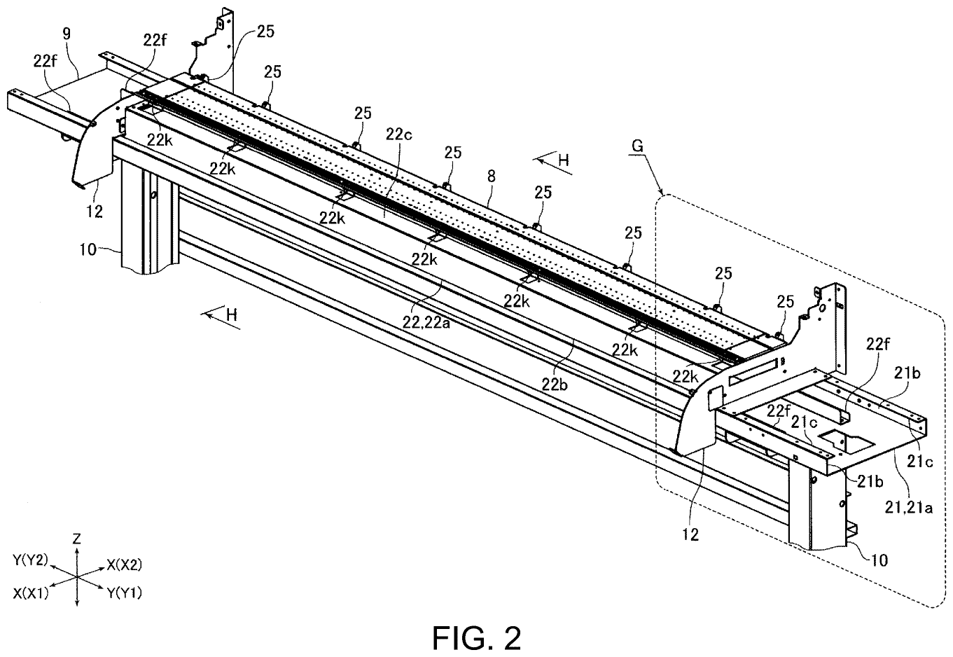

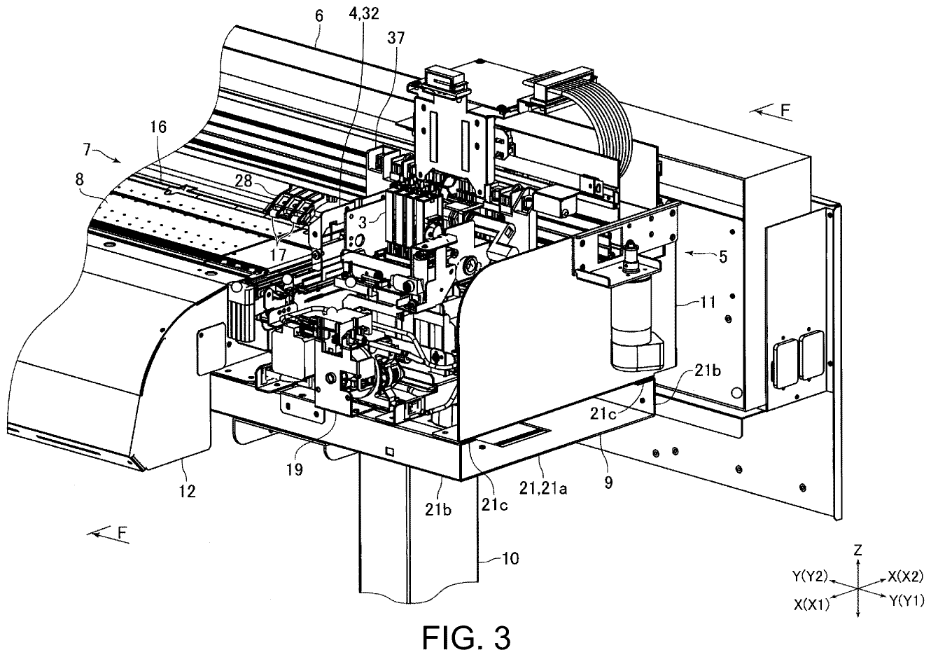

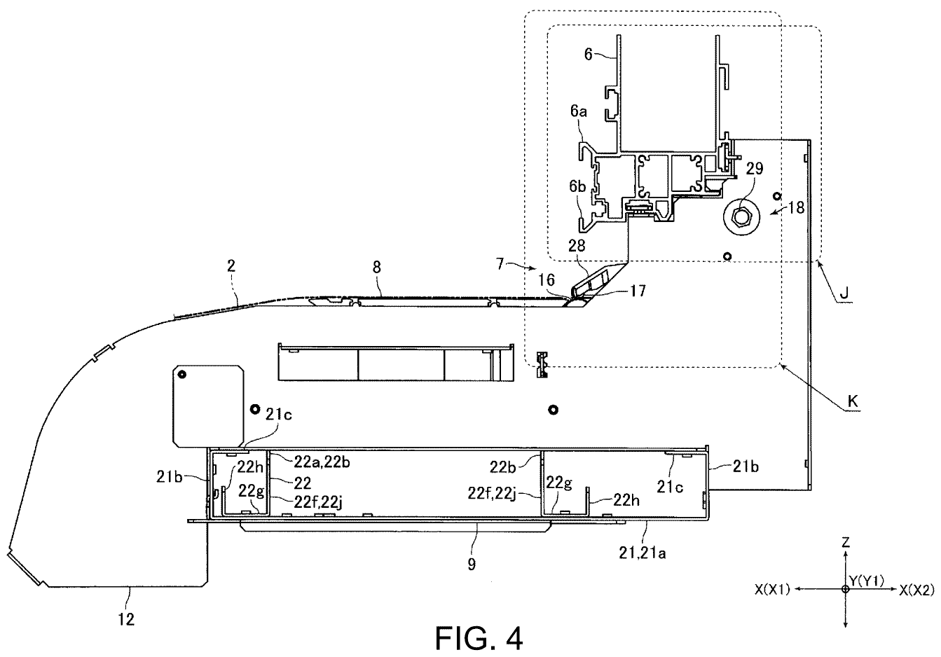

FIG. 1 is a perspective view of an inkjet printer 1 according to an embodiment of the present invention. FIG. 2 is a perspective view illustrating a platen 8, a main body frame 9, an upper end portion of a supporting leg 10, and a side plate 12 illustrated in FIG. 1 in an extracted manner. FIG. 3 is an enlarged view describing a configuration of portion E in FIG. 1. FIG. 4 is a side view illustrating a Y bar 6, a medium transporting mechanism 7, the platen 8, the main body frame 9, and the side plate 12 from the F-F direction of FIG. 3.

The inkjet printer 1 (hereinafter referred to as a “printer 1”) of the present embodiment is, for example, a business inkjet printer, and performs printing on a medium 2 by ejecting ink (see FIG. 4). The medium 2 is, for example, printing paper, fabric, resin film, or the like. The printer 1 includes an inkjet head 3 (see FIG. 3, hereinafter referred to as a “head 3”) configured to eject ink toward a medium 2, a carriage 4 on which the head 3 is mounted, a carriage driving mechanism 5 configured to move the carriage 4 in a main scanning direction (Y direction in FIG. 1 etc.) that is a width direction of the medium 2, and a Y bar 6 serving as a carriage holding member configured to hold the carriage 4 so as to be movable in the main scanning direction.

Furthermore, the printer 1 further includes a medium transporting mechanism 7 configured to transport the medium 2 in a sub-scanning direction (X direction in FIG. 1 etc.) orthogonal to an up-down direction (vertical direction, Z direction in FIG. 1 etc.) and the main scanning direction, a platen 8 on which the medium 2 at the time of printing is placed, a main body frame 9 for supporting the platen 8 from the lower side, a plurality of supporting legs 10 to which the main body frame 9 is fixed at upper end portions, and side plates 11 and 12 fixed to the main body frame 9. The printer 1 of the present embodiment includes two supporting legs 10, two side plates 11, and two side plates 12. The side plate 12 of the present embodiment is a second side plate.

In the following description, the main scanning direction (Y direction) is assumed as a “left-right direction” and the sub scanning direction (X direction) is assumed as a “front-back direction”. Furthermore, the Y1 direction side of FIG. 1 or the like, which is one side in the left-right direction, is defined as the “right” side, the Y2 direction side of FIG. 1 or the like on the opposite side of the right side is defined as the “left” side, the X1 direction side of FIG. 1 or the like, which is one side in the front-back direction, is defined as the “front” side, and the X2 direction side of FIG. 1 or the like on the opposite side of the front side is defined as the “back” side. The left-right direction (Y direction) of the present embodiment is the width direction of the medium 2. In addition, the front-back direction (X direction) is a first direction that is a direction orthogonal to the left-right direction, which is the width direction of the medium 2, and the up-down direction. Furthermore, one side in the first direction (i.e., one side in the sub-scanning direction, the X1 direction side) is a front side, and the other side in the first direction (i.e., the other side in the sub-scanning direction, the X2 direction side) is a back side.

The head 3 ejects ink downward. A plurality of nozzles for ejecting ink are formed on a lower surface of the head 3. The head 3 includes a piezoelectric element (piezoelectric element) for ejecting ink from the nozzle. For example, a plurality of heads 3 are mounted on the carriage 4. The carriage driving mechanism 5 includes, for example, two pulleys, a belt that is bridged between the two pulleys and that has one part fixed to the carriage 4, and a motor that rotates the pulleys. A specific configuration of the carriage 4 will be described later.

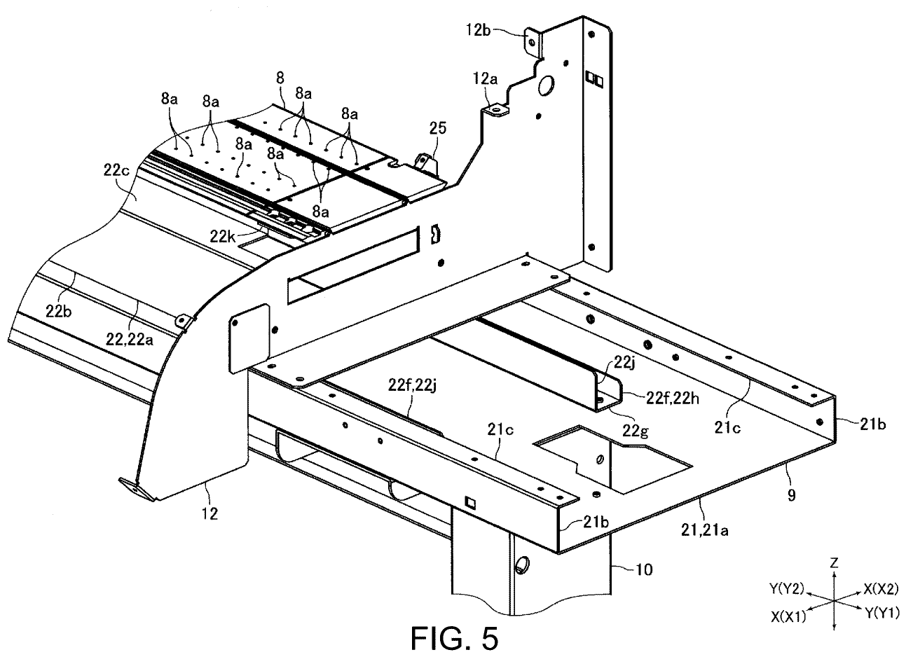

The platen 8 is formed in an elongated shape elongated in the left-right direction. The length of the platen 8 in the left-right direction is, for example, about 1600 mm. The platen 8 is disposed on the lower side of the head 3. The platen 8 is formed with a plurality of suction holes 8a (see FIG. 5) for sucking the medium 2 at the time of printing. A large number of suction holes 8a are formed over substantially the entire area of the platen 8. The Y bar 6 is formed in an elongated shape elongated in the left-right direction. The Y bar 6 is disposed on the back side than the platen 8 and the upper side than the platen 8. A specific configuration of the Y bar 6 will be described later.

The main body frame 9 is formed in an elongated shape elongated in the left-right direction. The two supporting legs 10 are disposed at intervals in the left-right direction. The two supporting legs 10 support both end portions of the main body frame 9 in the left-right direction from the lower side. The two supporting legs 10 are disposed on the inner side in the left-right direction than both ends in the left-right direction of the main body frame 9. The side plates 11 are fixed to both ends of the main body frame 9 in the left-right direction. The side plates 12 are fixed to both end portions of the main body frame 9 in the left-right direction. The two side plates 12 are disposed on the inner side of the two side plates 11 in the left-right direction. Specific configurations of the main body frame 9 and the side plates 12 will be described later.

The medium transporting mechanism 7 includes a transportation roller (grid roller) 16 for transporting the medium 2 in the front-back direction, a plurality of pinch rollers 17 disposed to face the transportation roller 16, and a rotation driving mechanism for rotating the transportation roller 16. The medium transporting mechanism 7 includes, for example, about 20 pinch rollers 17. The transportation roller 16 and the pinch roller 17 are rotatable with the left-right direction as an axial direction of rotation. The transportation roller 16 is disposed on the back side of the platen 8. The pinch roller 17 is disposed on the upper side of the transportation roller 16 and faces the transportation roller 16 from the upper side. The rotation driving mechanism includes a motor and a power transmission mechanism that transmits power of the motor to the transportation roller 16.

The medium 2 is transported while being sandwiched between the transportation roller 16 and the pinch roller 17 in the up-down direction. Furthermore, the medium transporting mechanism 7 further includes a pinch roller moving mechanism 18 configured to move the pinch roller 17 between a medium holding position at where a part of the medium 2 is sandwiched between the plurality of pinch rollers 17 and the transportation roller 16 and a retracted position at where the plurality of pinch rollers 17 are separated from the transportation roller 16. A specific configuration of the pinch roller moving mechanism 18 will be described later.

Furthermore, the printer 1 also includes a maintenance unit 19 for preventing clogging of a plurality of nozzles formed on the lower surface of the head 3. In the maintenance unit 19, cleaning of the head 3 is carried out so as not to cause clogging in the plurality of nozzles of the head 3. For example, in the maintenance unit 19, purging for forcibly sucking ink in the nozzles of the head 3, flushing for forcibly ejecting ink from the nozzles of the head 3, and wiping for wiping the lower surface of the head 3 with a predetermined wiper member are performed. The maintenance unit 19 is attached to a right end portion of the main body frame 9.

### Configurations of Main Body Frame and Peripheral Portion of Main Body Frame

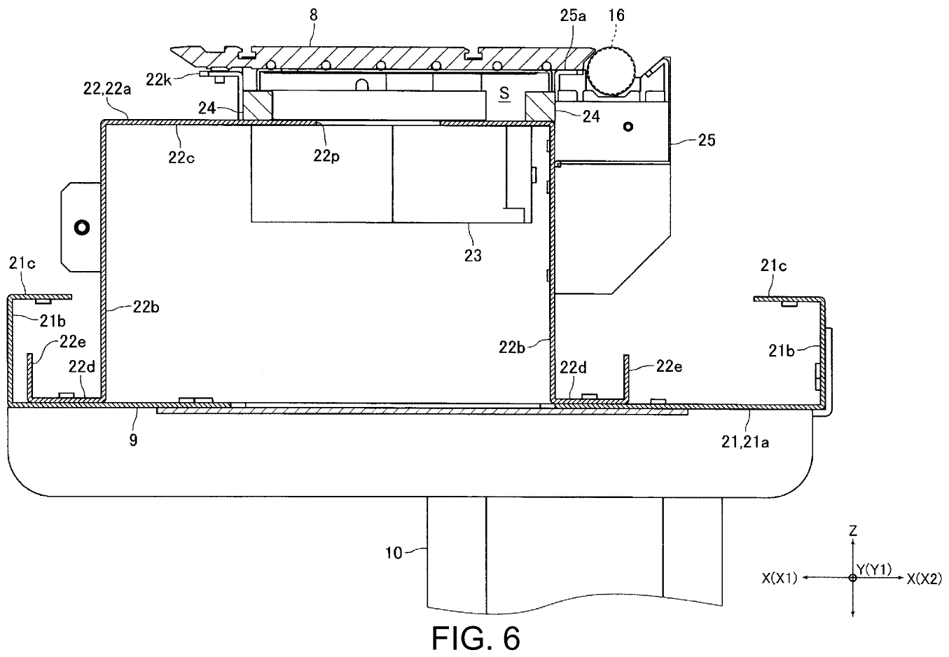

FIG. 5 is an enlarged view of portion G in FIG. 2. FIG. 6 is a cross-sectional view of H-H cross section in FIG. 2.

The main body frame 9 includes a first frame 21 and a second frame 22 formed in an elongated shape elongated in the left-right direction. The first frame 21 and the second frame 22 are made of a metal material. Furthermore, the first frame 21 and the second frame 22 are formed by bending a thin flat plate-shaped metal plate formed in a predetermined shape into a predetermined shape.

The first frame 21 includes a flat plate-shaped fixed portion 21a placed and fixed on the two supporting legs 10. The fixed portion 21a is formed in a flat plate shape elongated in the left-right direction. Specifically, the fixed portion 21a is formed in a rectangular flat plate shape elongated in the left-right direction. The thickness direction of the fixed portion 21a coincides with the up-down direction. In addition, the direction of the long side of the fixed portion 21a formed in a rectangular shape coincides with the left-right direction, and the direction of the short side of the fixed portion 21a coincides with the front-back direction.

The first frame 21 includes, in addition to the fixed portion 21a, side surface portions 21b rising upward from both ends in the front-back direction of the fixed portion 21a, and upper surface portions 21c extending toward the inner side in the front-back direction from upper ends of the side surface portions 21b. The side surface portion 21b and the upper surface portion 21c are formed in a rectangular flat plate shape elongated in the left-right direction. The thickness direction of the side surface portion 21b coincides with the front-back direction, and the thickness direction of the upper surface portion 21c coincides with the up-down direction.

The first frame 21 of the present embodiment includes the fixed portion 21a, the two side surface portions 21b, and the two upper surface portions 21c, and is formed in a lip groove steel shape in which both sides and an upper side in the left-right direction are opened (see FIG. 6). The cross-sectional shape of the first frame 21 is substantially horseshoe shaped (substantially U-shaped) with the upper side opened. The fixed portion 21a is fixed to the upper surface of the supporting leg 10. Both end portions in the left-right direction of the fixed portion 21a are fixed to the supporting leg 10. The length of the first frame 21 in the left-right direction is longer than the interval of the two supporting legs 10 in the left-right direction. Both end faces of the first frame 21 in the left-right direction are disposed on the outer side in the left-right direction than the two supporting legs 10.

The second frame 22 includes a main frame portion 22a formed in an elongated shape elongated in the left-right direction and formed in a groove steel shape in which both sides and a lower side in the left-right direction are opened. The main frame portion 22a includes two side surface portions 22b constituting side surfaces of the main frame portion 22a in the front-back direction, and an upper surface portion 22c connecting upper ends of the two side surface portions 22b, and a cross-sectional shape of the main frame portion 22a is a horseshoe shape (U-shape) in which a lower side is opened. The side surface portions 22b and the upper surface portion 22c are formed in a rectangular flat plate shape elongated in the left-right direction. The thickness direction of the side surface portion 22b coincides with the front-back direction, and the thickness direction of the upper surface portion 22c coincides with the up-down direction. The height of the side surface portion 22b is higher than the height of the side surface portion 21b.

In addition, the second frame 22 includes bottom surface portions 22d extending toward the outer side in the front-back direction from the lower ends of the side surface portions 22b, and outer side surface portions 22e rising toward the upper side from the outer side ends in the front-back direction of the bottom surface portions 22d. The bottom surface portion 22d and the outer side surface portion 22e are formed in a rectangular flat plate shape elongated in the left-right direction. The thickness direction of the bottom surface portion 22d coincides with the up-down direction, and the thickness direction of the outer side surface portion 22e coincides with the front-back direction. Furthermore, the second frame 22 includes a reinforcing portion 22f extending toward the outer side in the left-right direction from the main frame portion 22a.

The reinforcing portion 22f is formed at two locations in the front-back direction on the right side of the main frame portion 22a, and is formed at two locations in the front-back direction on the left side of the main frame portion 22a. That is, the second frame 22 includes four reinforcing portions 22f. The reinforcing portion 22f includes a bottom surface portion 22g connected to the bottom surface portion 22d, an outer side surface portion 22h connected to an outer side end in the front-back direction of the bottom surface portion 22g and connected to the outer side surface portion 22e, and an inner side surface portion 22j connected to an inner side end in the front-back direction of the bottom surface portion 22g and connected to a lower end portion of the side surface portion 22b, and is formed in a groove steel shape in which an upper side is opened (see FIG. 5).

The length of the first frame 21 in the left-right direction is longer than the length of the second frame 22 in the left-right direction. That is, the length of the first frame 21 in the left-right direction is longer than the length of the main frame portion 22a in the left-right direction. The length of the fixed portion 21a in the left-right direction is longer than the length of the main frame portion 22a in the left-right direction. The width of the first frame 21 in the front-back direction is wider than the width of the second frame 22 in the front-back direction. That is, the width of the fixed portion 21a in the front-back direction is wider than the width of the main frame portion 22a in the front-back direction.

The second frame 22 is fixed to the upper surface of the fixed portion 21a. Specifically, the bottom surface portions 22d and 22g in contact with the upper surface of the fixed portion 21a are fixed to the upper surface of the fixed portion 21a with a plurality of screws. That is, the main frame portion 22a is fixed to the upper surface of the fixed portion 21a via the bottom surface portions 22d and 22g, and the reinforcing portion 22f is fixed to the upper surface of the fixed portion 21a. Both end faces of the second frame 22 in the left-right direction are disposed on the inner side in the left-right direction than both end faces in the left-right direction of the first frame 21. The heights of the outer side surface portions 22e, 22h are lower than the height of the side surface portion 21b.

The length of the main frame portion 22a in the left-right direction is shorter than the interval between the two supporting legs 10 in the left-right direction. The two supporting legs 10 are disposed on the outer side of the main frame portion 22a in the left-right direction. That is, the main frame portion 22a is disposed between the two supporting legs 10 in the left-right direction. Furthermore, the length of the second frame 22 in the left-right direction is longer than the interval of the two supporting legs 10 in the left-right direction. Both end faces of the second frame 22 in the left-right direction are disposed on the outer side in the left-right direction than the two supporting legs 10. That is, the reinforcing portion 22f extends toward the outer side in the left-right direction from the main frame portion 22a, and extends to the outer side in the left-right direction than the upper side of the supporting leg 10.

A roller supporting portion 25 configured to rotatably support the transportation roller 16 is attached to the main frame portion 22a (see FIG. 6). That is, the printer 1 includes the roller supporting portion 25 configured to rotatably support the transportation roller 16. The roller supporting portion 25 is fixed to the back surface of the side surface portion 22b disposed on the back side. A plurality of roller supporting portions 25 arrayed at constant intervals in the left-right direction are attached to the main frame portion 22a (see FIG. 2). The roller supporting portion 25 includes a bearing configured to rotatably support the transportation roller 16.

The roller supporting portion 25 is formed with a platen supporting portion 25a to which the platen 8 is fixed (see FIG. 6). That is, the printer 1 includes the platen supporting portion 25a that is fixed to the second frame 22 and to which the platen 8 is fixed. Furthermore, the second frame 22 is formed with a platen supporting portion 22k to which the platen 8 is fixed. That is, the printer 1 includes the platen supporting portion 22k that is formed on the second frame 22 and to which the platen 8 is fixed.

The second frame 22 is formed with a plurality of platen supporting portions 22k arrayed at constant intervals in the left-right direction (see FIG. 2). The platen supporting portion 22k is formed by cutting and raising a portion on the front end side of the upper surface portion 22c of the main frame portion 22a toward the upper side. The upper end faces of the platen supporting portions 22k and 25a are planes orthogonal to the up-down direction. The front end portion of the platen 8 is placed and fixed on the upper end face of the platen supporting portion 22k, and the back end portion of the platen 8 is placed and fixed on the upper end face of the platen supporting portion 25a (see FIG. 6).

The width of the platen 8 in the left-right direction is substantially equal to the width of the main frame portion 22a in the left-right direction. The platen 8 is disposed on the upper side of the main frame portion 22a. As described above, the platen 8 is formed with a plurality of suction holes 8a for sucking the medium 2 at the time of printing. A space S communicating with the plurality of suction holes 8a is formed between the upper surface of the main frame portion 22a (i.e., the upper surface of the upper surface portion 22c) and the lower surface of the platen 8 (see FIG. 6). The space S is a space having relatively high sealability.

A fan 23 for discharging air from the space S is attached to the main frame portion 22a. Specifically, the fan 23 is attached to the lower surface of the upper surface portion 22c. As illustrated in FIG. 6, an opening 22p through which the air discharged from the space S passes is formed in the upper surface portion 22c. In the printer 1, when the fan 23 is operated and the air is discharged from the space S, the medium 2 is sucked to the plurality of suction holes 8a. The space S is an air chamber for sucking the medium 2. Note that a sponge 24 for enhancing sealability of the space S is disposed on the lower side of the front end portion and the back end portion of the platen 8 (see FIG. 6).

As described above, the maintenance unit 19 is attached to the right end portion of the main body frame 9. The maintenance unit 19 is disposed on the right side of the main frame portion 22a. That is, the maintenance unit 19 is disposed on one side of the main frame portion 22a in the left-right direction. The maintenance unit 19 is attached to the upper surface side of the first frame 21. Specifically, as illustrated in FIG. 3, the maintenance unit 19 is fixed to the upper surfaces of the two upper surface portions 21c.

### Configurations of Y Bar and Side Plate

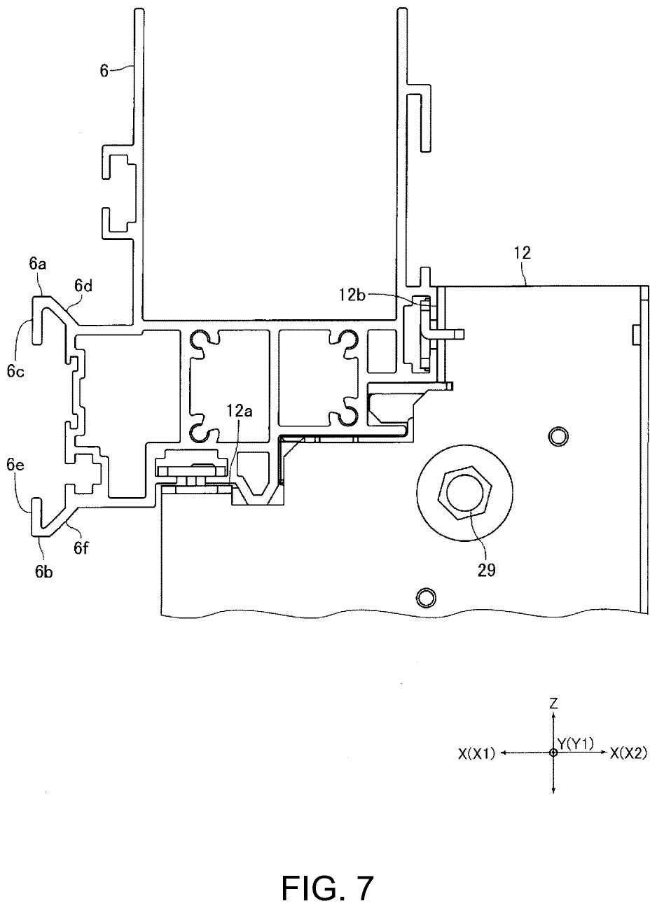

FIG. 7 is an enlarged view of portion J in FIG. 4.

The Y bar 6 is formed of an extruded material made of an aluminum alloy. As described above, the Y bar 6 is formed in an elongated shape elongated in the left-right direction. Guide rails 6a and 6b for guiding the carriage 4 in the left-right direction (main scanning direction) are formed on the front surface side of the Y bar 6. A specific configuration of the guide rails 6a and 6b will be described later.

The side plates 11 and 12 are formed by bending a thin flat plate-shaped metal plate formed in a predetermined shape into a predetermined shape. As described above, the side plates 11 are fixed to both ends of the main body frame 9 in the left-right direction. The side plates 11 are attached to the upper surface side of the first frame 21 at both ends of the main body frame 9 in the left-right direction. Specifically, the side plates 11 are fixed to the upper surfaces of the two upper surface portions 21c at both ends of the main body frame 9 in the left-right direction. Both end portions of the Y bar 6 in the left-right direction are respectively fixed to the side plate 11.

As described above, the side plates 12 are fixed to both end portions of the main body frame 9 in the left-right direction. Furthermore, the two side plates 12 are disposed on the inner side of the two side plates 11 in the left-right direction. The interval between the two side plates 12 in the left-right direction is slightly larger than the lengths in the left-right direction of the platen 8 and the main frame portion 22a. The side plates 12 are disposed on both sides in the left-right direction of the platen 8 and the main frame portion 22a. That is, the platen 8 and the main frame portion 22a are disposed between the two side plates 12 in the left-right direction.

The side plates 12 are attached to the upper surface side of the first frame 21 at both end portions of the main body frame 9 in the left-right direction. Specifically, the side plates 12 are fixed to the upper surfaces of the two upper surface portions 21c at both end portions of the main body frame 9 in the left-right direction. That is, the side plates 12 are fixed to the upper end sides of the two side surface portions 21b at both end portions of the main body frame 9 in the left-right direction. At the right end portion of the printer 1, the maintenance unit 19 is disposed between the side plate 11 and the side plate 12 in the left-right direction.

Both end portions of the Y bar 6 in the left-right direction are respectively fixed to the side plate 12. That is, the Y bar 6 is fixed to the two side plates 12. Fixing surfaces 12a and 12b to which the Y bar 6 is fixed are formed on the side plate 12 (see FIGS. 5 and 7). The fixing surface 12a is a plane orthogonal to the up-down direction. The fixing surface 12b is a plane orthogonal to the front-back direction. The fixing surface 12b is disposed on the back side and the upper side of the fixing surface 12a. The fixing surface 12a of the present embodiment is a first fixing surface, and the fixing surface 12b is a second fixing surface.

Both end portions of the Y bar 6 in the left-right direction are respectively placed on the back end portion of the side plate 12. The front lower end portion of the Y bar 6 is placed on the fixing surface 12a. The front lower end portion of the Y bar 6 is fixed to the fixing surface 12a. Specifically, the front lower end portion of the Y bar 6 is fixed to the fixing surface 12a with a screw. The back lower end portion of the Y bar 6 is in contact with the fixing surface 12b from the front side. The back lower end portion of the Y bar 6 is fixed to the fixing surface 12b. Specifically, the back lower end portion of the Y bar 6 is fixed to the fixing surface 12b with a screw.

### Pinch Roller Moving Mechanism

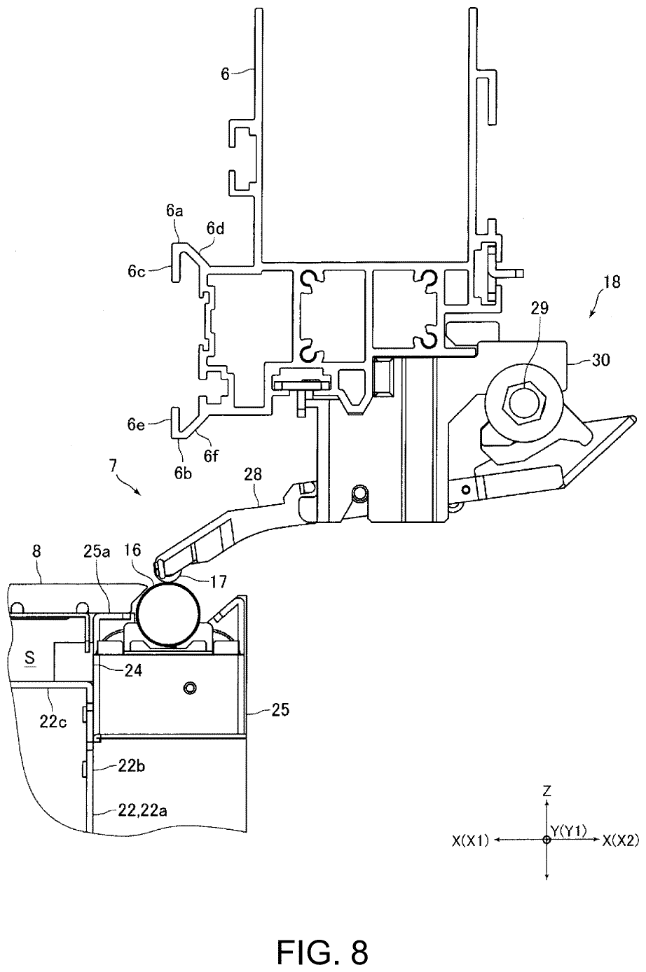

FIG. 8 is an enlarged view of portion K in FIG. 4 in a state where the side plate 12 is removed.

The pinch roller moving mechanism 18 includes a pinch roller holding portion 28 configured to rotatably hold the pinch roller 17, a turning shaft 29 to which the pinch roller holding portion 28 is fixed, and a driving mechanism configured to turn the turning shaft 29. The pinch roller 17 is rotatably held at a front end portion of the pinch roller holding portion 28. A back end portion of the pinch roller holding portion 28 is fixed to the turning shaft 29. A plurality of pinch roller holding portions 28 are fixed to the turning shaft 29. The turning shaft 29 is turnable with the left-right direction as an axial direction of turn. Both end portions of the turning shaft 29 are turnably supported by the two side plates 12.

The driving mechanism includes a drive source such as a motor and a power transmission mechanism that transmits power of the drive source to the turning shaft 29. The driving mechanism turns the turning shaft 29 to move the pinch roller 17 between a medium holding position (position illustrated in FIG. 8) where a part of the medium 2 is sandwiched between the plurality of pinch rollers 17 and the transportation roller 16 and a retracted position where the plurality of pinch rollers 17 are separated from the transportation roller 16. When the medium 2 is being set in the printer 1, the pinch roller 17 is moved to the retracted position, and when the medium 2 is set in the printer 1, the pinch roller 17 is moved to the medium holding position.

Note that the pinch roller holding portion 28 is manually movable in the left-right direction with respect to the turning shaft 29. The pinch roller holding portion 28 is attached to a clamp mechanism 30 (see FIG. 8). The clamp mechanism 30 is switchable between a clamped state in which the pinch roller holding portion 28 is fixed to the turning shaft 29 and an unclamped state in which the pinch roller holding portion 28 is movable in the left-right direction with respect to the turning shaft 29. The clamp mechanism 30 is held at the lower end portion of the Y bar 6 so as to be movable in the left-right direction.

### Configuration of Carriage and Guide Rail

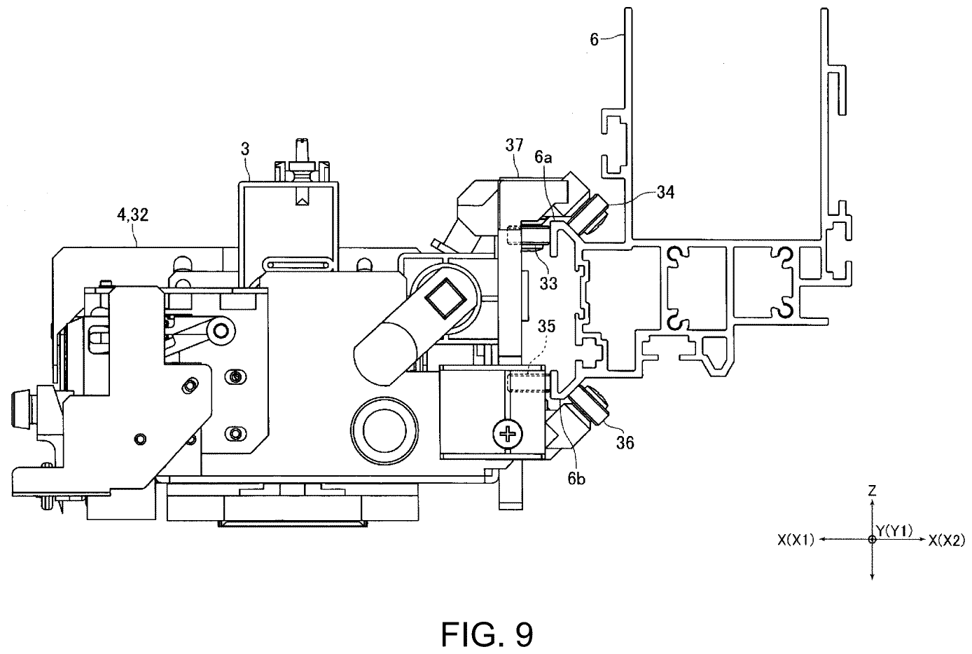

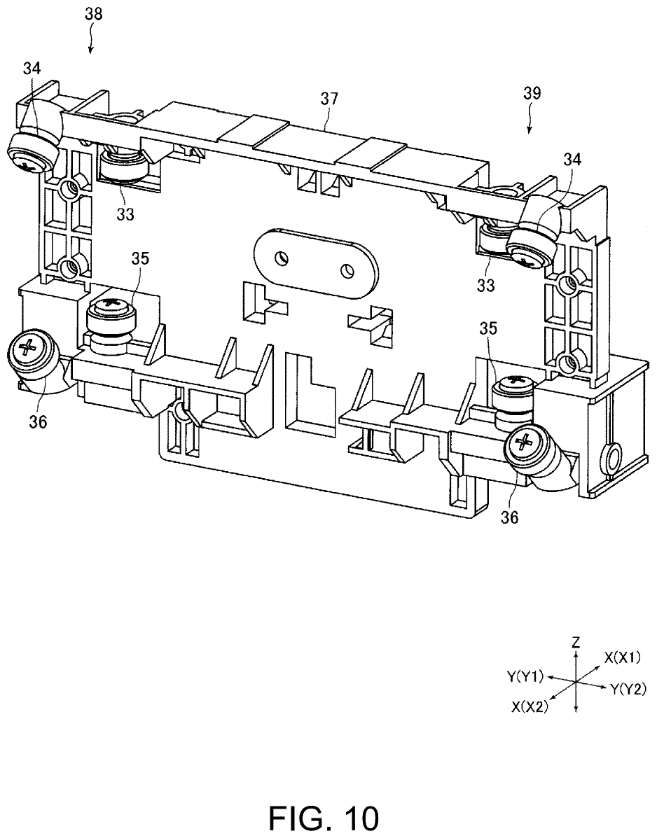

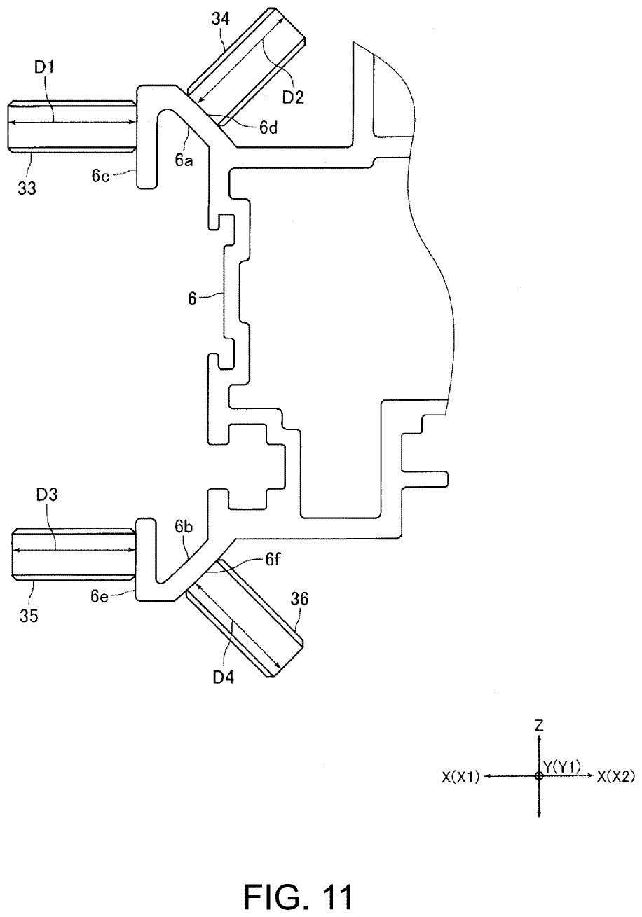

FIG. 9 is a side view illustrating the head 3, the carriage 4, and the Y bar 6 illustrated in FIG. 1 in an extracted manner. FIG. 10 is a rear perspective view illustrating guide rollers 33 to 36 and a roller holding member 37 illustrated in FIG. 9 in an extracted manner. FIG. 11 is a side view illustrating the guide rails 6a and 6b and the guide rollers 33 to 36 illustrated in FIG. 9 in an extracted manner.

The carriage 4 includes a carriage main body 32 to which the head 3 is attached, and a plurality of guide rollers 33 to 36 for guiding the carriage 4 in the left-right direction (main scanning direction). The carriage main body 32 is disposed on the front side of the Y bar 6. That is, the head 3 attached to the carriage main body 32 and mounted on the carriage 4 is disposed on the front side of the Y bar 6. The carriage main body 32 includes a roller holding member 37 configured to rotatably hold the plurality of guide rollers 33 to 36. That is, the plurality of guide rollers 33 to 36 are rotatably attached to the carriage main body 32. The roller holding member 37 is made of a resin material. The roller holding member 37 constitutes a back end portion of the carriage main body 32.

The guide rollers 33 to 36 are bearings (bearings). For example, the guide rollers 33 to 36 are ball bearings or roller bearings. In the present embodiment, as illustrated in FIG. 10, the carriage 4 includes four guide rollers 33 to 36 attached to the right end side of the roller holding member 37 and four guide rollers 33 to 36 attached to the left end side of the roller holding member 37. That is, in the present embodiment, the carriage 4 includes a total of eight guide rollers 33 to 36 including two guide rollers 33, two guide rollers 34, two guide rollers 35 and two guide rollers 36.

In the present embodiment, the carriage 4 includes a guide roller group 38 including four guide rollers 33 to 36 attached to the right end side of the roller holding member 37, and a guide roller group 39 including four guide rollers 33 to 36 attached to the left end side of the roller holding member 37 (see FIG. 10). That is, the guide roller groups 38 and 39 are attached to both end sides of the carriage main body 32 in the left-right direction. Furthermore, the guide roller groups 38 and 39 are attached to the back end portion of the carriage main body 32.

The guide rollers 33 and 34 are attached to the upper end side (i.e., the upper end side of the carriage main body 32) of the roller holding member 37. The two guide rollers 33 are disposed on the inner side in the left-right direction than the two guide rollers 34. The guide roller 33 can rotate with the up-down direction as an axial direction of rotation with respect to the roller holding member 37. The guide roller 34 can rotate with the obliquely backward and downward direction as an axial direction of rotation with respect to the roller holding member 37. A fixed shaft serving as a rotation center of the guide roller 33 and a fixed shaft serving as a rotation center of the guide roller 34 are fixed to the roller holding member 37.

The guide rollers 35 and 36 are attached to the lower end side (i.e., the lower end side of the carriage main body 32) of the roller holding member 37. The two guide rollers 35 are disposed on the inner side in the left-right direction than the two guide rollers 36. The guide roller 35 can rotate with the up-down direction as an axial direction of rotation with respect to the roller holding member 37. The guide roller 36 can rotate with the obliquely backward and upward direction as an axial direction of rotation with respect to the roller holding member 37. A fixed shaft serving as a rotation center of the guide roller 35 and a fixed shaft serving as a rotation center of the guide roller 36 are fixed to the roller holding member 37.

The guide roller 33 of the present embodiment is a first guide roller, the guide roller 34 is a second guide roller, the guide roller 35 is a third guide roller, and the guide roller 34 is a fourth guide roller. That is, the guide roller groups 38 and 39 include a first guide roller, a second guide roller, a third guide roller, and a fourth guide roller.

An outer diameter D1 (see FIG. 11) of the guide roller 33 is different from outer diameters D2 to D4 (see FIG. 11) of the guide rollers 34 to 36. That is, the outer diameters D1 of the two guide rollers 33 among the eight guide rollers 33 to 36 are different from the outer diameters D2 to D4 of the remaining six guide rollers 34 to 36 excluding the guide rollers 33. Specifically, the outer diameter D1 of the guide roller 33 is larger than the outer diameters D2 to D4 of the remaining guide rollers 34 to 36.

Furthermore, the outer diameter D2 of the guide roller 34, the outer diameter D3 of the guide roller 35, and the outer diameter D4 of the guide roller 36 are equal to each other. That is, the carriage 4 includes two types of guide rollers 33 to 36 having different outer diameters. For example, the outer diameter D1 of the guide roller 33 is 13 mm, and the outer diameters D2 to D4 of the guide rollers 34 to 36 are 12 mm. That is, the outer diameter D1 of the guide roller 33 is larger than the outer diameters D2 to D4 of the guide rollers 34 to 36 by 1 mm. Note that the difference between the outer diameter D1 of the guide roller 33 and the outer diameters D2 to D4 of the guide rollers 34 to 36 may be less than 1 mm or may be more than 1 mm.

As described above, the guide rails 6a and 6b are formed on the front surface side of the Y bar 6. As illustrated in FIG. 11, the guide rail 6a is formed with a contact surface 6c with which the guide roller 33 comes into contact from the front side, and a contact surface 6d with which the guide roller 34 comes into contact from the obliquely backward upper side. That is, contact surfaces 6c and 6d with which the guide rollers 33 and 34 come into contact are formed on the guide rail 6a. The guide rail 6b is formed with a contact surface 6e with which the guide roller 35 comes into contact from the front side, and a contact surface 6f with which the guide roller 36 comes into contact from the obliquely backward lower side. That is, the contact surfaces 6e and 6f with which the guide rollers 35 and 36 come into contact are formed on the guide rail 6b.

The contact surfaces 6c and 6e are planes orthogonal to the front-back direction. The contact surfaces 6c and 6e are rectangular planes elongated in the left-right direction. The contact surface 6d is a plane orthogonal to the obliquely backward upward direction. The contact surface 6f is a plane orthogonal to the obliquely backward downward direction. The contact surfaces 6d and 6f are rectangular planes elongated in the left-right direction. However, the contact surfaces 6d and 6f may be curved surfaces having a large radius of curvature. The contact surface 6c of the present embodiment is a first contact surface, the contact surface 6d is a second contact surface, the contact surface 6e is a third contact surface, and the contact surface 6f is a fourth contact surface. In addition, the guide rail 6a of the present embodiment is a first guide rail, and the guide rail 6b is a second guide rail.

Note that the guide roller 36 is biased toward the contact surface 6f by a spring member such as a torsion coil spring (not illustrated). Therefore, in the present embodiment, even if the component dimensions of the guide rails 6a and 6b, the guide rollers 33 to 36, the roller holding member 37, and the like vary, all of the guide rollers 33 to 36 can be brought into contact with each of the contact surfaces 6c to 6f.

### Main Effect of Present Embodiment

As described above, in the present embodiment, the main body frame 9 includes the fixed portion 21a formed in a flat plate shape elongated in the left-right direction and placed and fixed on the two supporting legs 10, and the main frame portion 22a formed in an elongated shape elongated in the left-right direction and formed in a groove steel shape in which both sides and the lower side in the left-right direction are opened. Furthermore, in the present embodiment, the width of the fixed portion 21a in the front-back direction is wider than the width of the main frame portion 22a in the front-back direction, and the main frame portion 22a is fixed to the upper surface of the fixed portion 21a.

That is, in the present embodiment, the main frame portion 21a fixed to the upper surface of the fixed portion 22a and the fixed portion 21a form a structural portion having a quadrangular tubular shape (square pipe shape) elongated in the left-right direction in the main body frame 9, where the structural portion having the quadrangular tubular shape elongated in the left-right direction is a main portion of the main body frame 9. Therefore, in the present embodiment, the weight of the main body frame 9 can be reduced while increasing the strength of the main body frame 9.

In the present embodiment, the first frame 21 includes flat plate-shaped side surface portions 21b rising toward the upper side from both ends in the front-back direction of the fixed portion 21a. Therefore, in the present embodiment, the strength of the first frame 21 can be increased as compared with a case where the first frame 21 is formed only by the flat plate-shaped fixed portion 21a. In particular, in the present embodiment, since the upper surface portion 21c is connected to the upper end of the side surface portion 21b and the first frame 21 is formed in a lip groove steel shape, the strength of the first frame 21 can be further increased. Therefore, in the present embodiment, the strength of the main body frame 9 can be further increased.

In the present embodiment, the second frame 22 includes a reinforcing portion 22f extending toward the outer side in the left-right direction from the main frame portion 22a. Furthermore, in the present embodiment, the reinforcing portion 22f fixed to the upper surface of the fixed portion 21a extends to the outer side in the left-right direction from the upper side of the supporting leg 10. Therefore, in the present embodiment, even if the fixed portion 21a is fixed to the two supporting legs 10 on the outer side in the left-right direction of the main frame portion 22a, the strength of the upper side portion of the supporting leg 10 serving as the fulcrum of the main body frame 9 supported by the two supporting legs 10 can be increased. Therefore, in the present embodiment, deformation of the main body frame 9 when a load acts on the main body frame 9 can be suppressed.

In the present embodiment, the roller supporting portion 25 configured to rotatably support the transportation roller 16 is attached to the main frame portion 22a. In the present embodiment, since the strength of the main body frame 9 can be increased, the transportation roller 16 can be appropriately supported by the main body frame 9 via the roller supporting portion 25 even if the roller supporting portion 25 that supports the transportation roller 16 receiving the reaction force from the medium 2 at the time of transportation or the like is fixed to the main frame portion 22a.

In the present embodiment, a plurality of suction holes 8a for sucking the medium 2 at the time of printing is formed in the platen 8. Furthermore, in the present embodiment, a space S through which the plurality of suction holes 8a communicate is formed between the upper surface of the main frame portion 22a and the lower surface of the platen 8, and a fan 23 for discharging air from the space S is attached to the main frame portion 22a. Therefore, in the present embodiment, the fan 23 attached to the main frame portion 22a can be used to discharge the air from the space S to the inner side of the main frame portion 22a formed in the groove steel shape. Therefore, in the present embodiment, the medium 2 at the time of printing can be sucked and fixed to the platen 8 with a relatively simple configuration.

In the present embodiment, the maintenance unit 19 is disposed on the right side of the main frame portion 22a and is attached to the upper surface side of the first frame 21. Therefore, in the present embodiment, even if the height of the maintenance unit 19 is high, the upper surface of the maintenance unit 19 can be disposed at an appropriate position with respect to the upper surface of the platen 8 disposed on the upper side of the main frame portion 22a by adjusting the height of the main frame portion 22a. Furthermore, the position of the upper surface of the platen 8 is set to a position where a predetermined gap is formed between the upper surface of the platen 8 and the lower surface of the head 3. Therefore, in the present embodiment, even if the height of the maintenance unit 19 is high, the upper surface of the maintenance unit 19 can be disposed at an appropriate position with respect to the lower surface of the head 3.

In the present embodiment, the Y bar 6 is also fixed to the two side plates 12 in addition to being fixed to the two side plates 11. Therefore, in the present embodiment, deformation such as bending of the Y bar 6 when a load acts on the Y bar 6 formed in an elongated shape elongated in the left-right direction can be effectively suppressed. Furthermore, in the present embodiment, since the side plates 12 are fixed to the upper surfaces of the two upper surface portions 21c at both end portions in the left-right direction of the main body frame 9, the two side surface portions 21b can be prevented from opening toward the outer side in the front-back direction by the side plates 12. Therefore, in the present embodiment, the strength of the first frame 12 can be increased.

As described above, in the present embodiment, the outer diameters D1 of the two guide rollers 33 among the eight guide rollers 33 to 36 are different from the outer diameters D2 to D4 of the remaining six guide rollers 34 to 36 excluding the guide rollers 33. That is, in the present embodiment, the guide rollers 33 having different outer diameters are included in the plurality of guide rollers 33 to 36 included in the carriage 4. Therefore, according to the study of the inventor of the present application, in the present embodiment, the periodic vibration of the carriage 4 moving in the main scanning direction can be suppressed.

Furthermore, according to the study of the inventor of the present application, in the carriage 4 moving in the main scanning direction, the vibration on the upper end side of the carriage 4 tends to be larger than the vibration on the lower end side of the carriage 4, but when the outer diameters D1 of the guide rollers 33 attached to the upper end side of the carriage main body 32 are larger than the outer diameters D2 to D4 of the remaining guide rollers 34 to 36 as in the present embodiment, the periodic vibration of the carriage 4 moving in the main scanning direction can be effectively suppressed.

### Modified Example of Main Body Frame

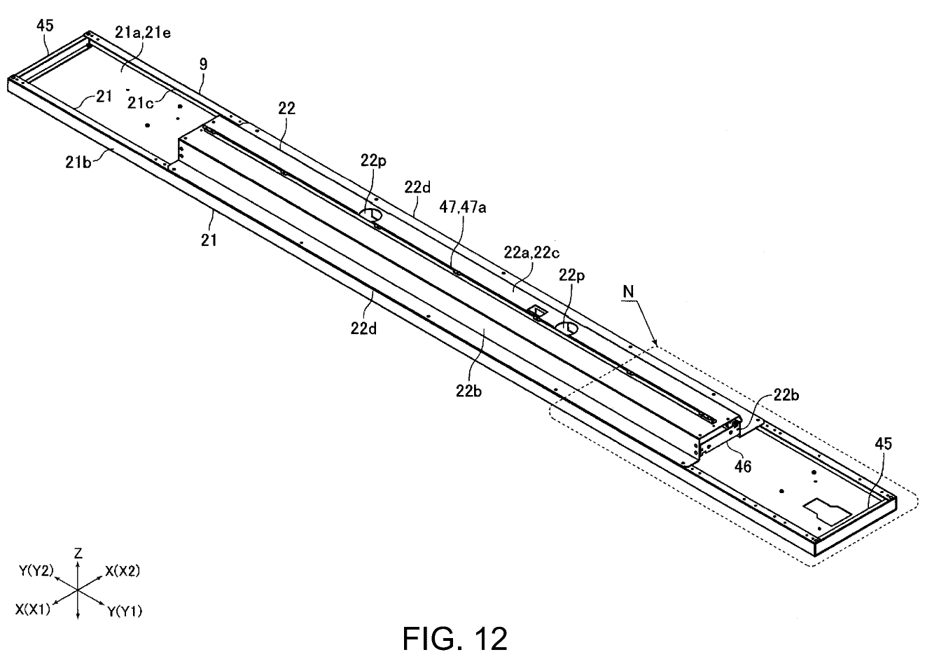

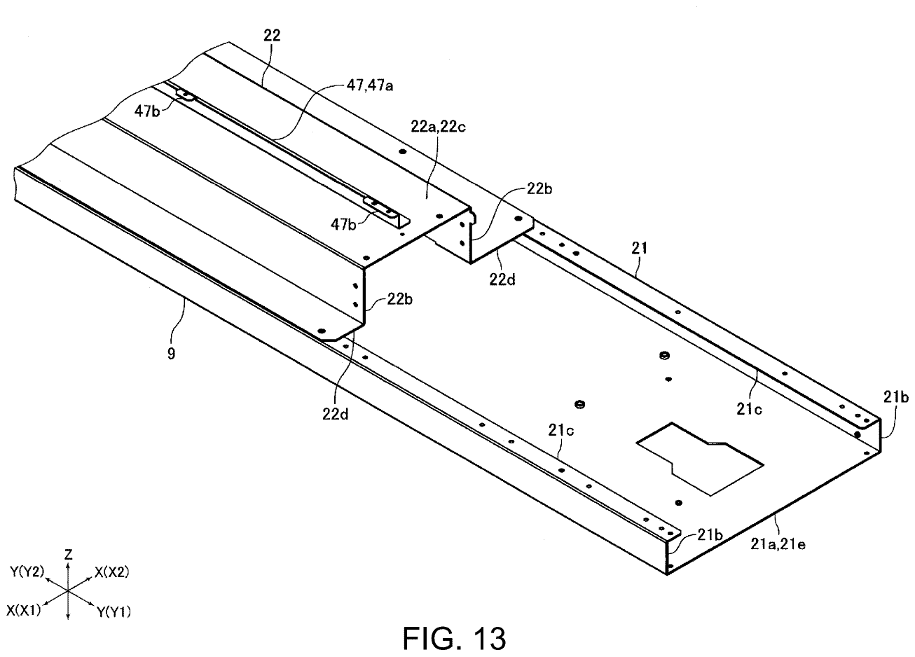

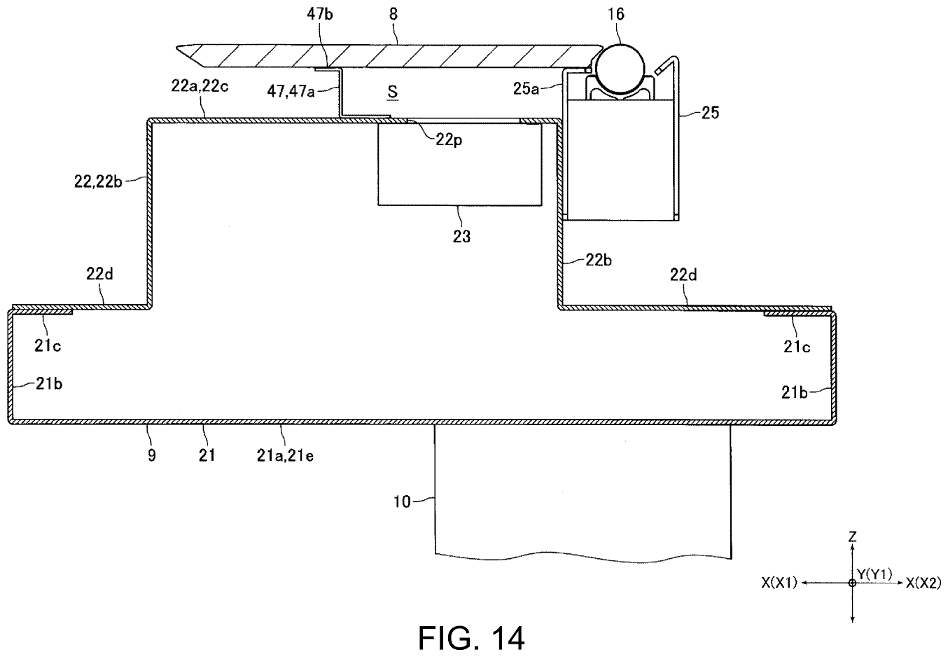

FIG. 12 is a perspective view for explaining a configuration of the main body frame 9 according to another embodiment of the present invention. FIG. 13 is an enlarged view of portion N in FIG. 12. FIG. 14 is a cross-sectional view for explaining the configuration of the main body frame 9 illustrated in FIG. 12. In FIGS. 12 to 14, the configurations similar to those in the above-described embodiment are denoted with the same reference numerals. Note that FIG. 14 illustrates a cross-sectional view of a cross section corresponding to the H-H cross section of FIG. 2.

The configuration of the main body frame 9 is not limited to the configuration of the main body frame 9 in the above-described embodiment (see FIGS. 12 to 14). In the main body frame 9 illustrated in FIGS. 12 to 14, the shape of the second frame 22 is different from the shape of the second frame 22 in the above-described embodiment. In this modified example, the reinforcing member 45 is fixed to both end portions in the left-right direction of the first frame 21, and a component fixing member 46 for fixing a predetermined component is fixed to both end portions in the left-right direction of the second frame 22. That is, in this modified example, the printer 1 includes the reinforcing member 45 and the component fixing member 46. Hereinafter, a configuration of a modified example of the main body frame 9 illustrated in FIGS. 12 to 14 will be described focusing on a difference from the main body frame 9 of the above-described embodiment. Note that in FIG. 13, illustration of the reinforcing member 45 and the component fixing member 46 is omitted.

Similarly to the embodiment described above, the main body frame 9 includes a first frame 21 and a second frame 22 formed in an elongated shape elongated in the left-right direction. The first frame 21 is formed similarly to the embodiment described above. That is, the first frame 21 includes the fixed portion 21a, the two side surface portions 21b, and the two upper surface portions 21c, and is formed in a lip groove steel shape in which both sides and an upper side in the left-right direction are opened.

In this modified example, the fixed portion 21a and the two side surface portions 21b constitute a second main frame portion 21e. The second main frame portion 21e is formed in an elongated shape elongated in the left-right direction and is formed in a groove steel shape in which both sides and an upper side in the left-right direction are opened. The reinforcing member 45 is fixed to both end portions in the left-right direction of the first frame 21 so as to close openings formed on both sides in the left-right direction of the first frame 21 having a lip groove steel shape. That is, the reinforcing member 45 closes openings formed on both sides in the left-right direction of the second main frame portion 21e having a groove steel shape.

Similarly to the embodiment described above, the second frame 22 includes a main frame portion 22a including two side surface portions 22b and an upper surface portion 22c. The main frame portion 22a is formed in an elongated shape elongated in the left-right direction and is formed in a groove steel shape in which both sides and a lower side in the left-right direction are opened. Furthermore, the second frame 22 includes a bottom surface portion 22d extending toward the outer side in the front-back direction from the lower end of the side surface portion 22b. That is, the second frame 22 includes two bottom surface portions 22d extending toward the outer side in the front-back direction from the lower end of the main frame portion 22a.

In this modified example, the width in the front-back direction of the bottom surface portion 22d disposed on the back side is wider than the width in the front-back direction of the bottom surface portion 22d disposed on the front side. Furthermore, in this modified example, the outer side surface portion 22e and the reinforcing portion 22f are not formed on second frame 22. The component fixing member 46 is fixed to the two side surface portions 22b so as to connect the two side surface portions 22b disposed at intervals in the front-back direction at both end portions in the left-right direction of the second frame 22 (i.e., at both end portions in the left-right direction of the main frame portion 22a).

Similarly to the embodiment described above, the length of the first frame 21 in the left-right direction is longer than the length of the main frame portion 22a in the left-right direction. That is, the length of the second main frame portion 21e in the left-right direction is longer than the length of the main frame portion 22a in the left-right direction. Furthermore, the width of the first frame 21 in the front-back direction (i.e., the width of the second main frame portion 21e in the front-back direction) is wider than the width of the main frame portion 22a in the front-back direction. On the other hand, in this modified example, the width of the first frame 21 in the front-back direction is equal to the width of the second frame 22 in the front-back direction.

The second frame 22 is disposed on the upper side of the first frame 21. Furthermore, the second frame 22 is fixed to the first frame 21. Specifically, the bottom surface portion 22d of the second frame 22 is fixed to the upper surface portion 21c while being placed on the upper surface portion 21c of the first frame 21. That is, the bottom surface portion 22d is fixed to the upper end side of the side surface portion 21b. The lower surface of the front side portion of the bottom surface portion 22d disposed on the front side is in contact with the upper surface of the upper surface portion 21c disposed on the front side, and the lower surface of the back side portion of the bottom surface portion 22d disposed on the back side is in contact with the upper surface of the upper surface portion 21c disposed on the back side.

The front side surface of the first frame 21 (i.e., the front surface of the side surface portion 21b disposed on the front side) and the front end face of the second frame 22 (i.e., the front end face of the bottom surface portion 22d disposed on the front side) are disposed at the same position in the front-back direction. The back side surface of the first frame 21 (i.e., the back surface of the side surface portion 21b disposed on the back side) and the back end face of the second frame 22 (i.e., the back end face of the bottom surface portion 22d disposed on the back side) are disposed at the same position in the front-back direction.

The bottom surface portion 22d is fixed to the upper surface portion 21c with a plurality of screws. In this modified example, a through hole through which a screw is inserted is formed in the bottom surface portion 22d, and a screw hole with which the screw is engaged is formed in the upper surface portion 21c. The screws are attached to the bottom surface portion 22d and the upper surface portion 21c from the upper side of the bottom surface portion 22d. Note that in the embodiment described above, the through hole through which the screw is inserted is formed in the fixed portion 21a, and the screw hole with which the screw is engaged is formed in the bottom surface portions 22d and 22g so that the distal end portion of the screw is not exposed to the outside of the main body frame 9 on the lower side of the main body frame 9. The screws are attached to the fixed portion 21a and the bottom surface portions 22d and 22g from the lower side of the fixed portion 21a.

Similarly to the embodiment described above, a roller supporting portion 25 configured to rotatably support the transportation roller 16 is attached to the main frame portion 22a. The roller supporting portion 25 is formed with a platen supporting portion 25a. In this modified example, the platen supporting member 47 serving as the platen supporting portion corresponding to the platen supporting portion 22k of the above-described embodiment is formed separately from the second frame 22. The platen supporting member 47 is fixed to the second frame 22.

The platen supporting member 47 is formed by bending a metal plate having a predetermined shape into a predetermined shape. The platen supporting member 47 includes a supporting member base portion 47a formed in a long shape elongated in the left-right direction, and a plurality of platen fixing portions 47b on which the platen 8 is placed and fixed. The shape of the supporting member base portion 47a when viewed from the left-right direction is, for example, a substantially L shape. The supporting member base portion 47a is fixed to the upper surface of the upper surface portion 22c. The platen fixing portion 47b extends toward the front side from the upper end of the supporting member base portion 47a. The upper surface of the platen fixing portion 47b is a plane orthogonal to the up-down direction. The plurality of platen fixing portions 47b are arrayed at predetermined intervals in the left-right direction.

Similarly to the embodiment described above, in this modified example, a space S is formed between the upper surface of the main frame portion 22a and the lower surface of the platen 8. A fan 23 for discharging air from the space S is attached to the main frame portion 22a. An opening 22p through which air discharged from the space S passes is formed in the upper surface portion 22c. The maintenance unit 19 is disposed on the right side of the main frame portion 22a. The maintenance unit 19 is fixed to the upper surfaces of the two upper surface portions 21c.

In this modified example, the second frame 22 includes the main frame portion 22a formed in an elongated shape elongated in the left-right direction and formed in a groove steel shape in which both sides and a lower side in the left-right direction are opened, and the bottom surface portion 22d extending toward the outer side in the front-back direction from a lower end of the main frame portion 22a. In addition, the first frame 21 includes the second main frame portion 21e formed in an elongated shape elongated in the left-right direction and formed in a groove steel shape in which both sides and an upper side in the left-right direction are opened. Furthermore, the bottom surface portion 22d of the second frame 22 is fixed to the upper end side of the side surface portion 21b of the second main frame portion 21e.

That is, in this modified example, the first frame 21 and the second frame 22 form a tubular structural portion whose outer shape when viewed from the left-right direction is a convex shape and which is elongated in the left-right direction in the main body frame 9, where this tubular structural portion elongated in the left-right direction is a main portion of the main body frame 9. Therefore, in this modified example as well, the weight of the main body frame 9 can be reduced while increasing the strength of the main body frame 9.

In this modified example, the bottom surface portion 22d is fixed to the upper surface portion 21c while being placed on the upper surface portion 21c of the first frame 21. Therefore, the fixed state of the bottom surface portion 22d fixed to the upper end side of the side surface portion 21b can be stabilized. Therefore, the strength of the main body frame 9 can be further increased. Moreover, since the bottom surface portion 22d in the state of being placed on the upper surface portion 21c merely needs to be fixed to the upper surface portion 21c, the fixing work of the bottom surface portion 22d is facilitated.

In this modified example, the reinforcing member 45 is fixed to both end portions in the left-right direction of the first frame 21 so as to close the openings formed on both sides in the left-right direction of the first frame 21. Therefore, even if the reinforcing portion 22f is not formed on the second frame 22, the strength of the main body frame 9 on both end sides in the left-right direction can be increased.

In this modified example, the platen supporting member 47 is formed separately from the second frame 22 and fixed to the second frame 22. Since the second frame 22 is formed in an elongated shape elongated in the left-right direction (e.g., the length of the second frame 22 in the left-right direction is about 1600 mm), when the platen supporting portion 22k is formed in the second frame 22, handling of the second frame 22 at the time of forming the platen supporting portion 22k becomes complicated, and the manufacturing cost of the second frame 22 integrally formed with the platen supporting portion 22k may increase. On the other hand, even if the second frame 22 is formed in an elongated shape elongated in the left-right direction, handling of the second frame 22 when the platen supporting member 47 formed separately is fixed to the second frame 22 is relatively easy, and thus in this modified example, the manufacturing cost of the second frame 22 in a state where the platen supporting member 47 is fixed can be reduced.

### Other Embodiments

The embodiment described above is an example of a preferred embodiment of the present invention, but the present invention is not limited thereto, and various modified examples can be made within a scope of not changing the gist of the present invention.

In the embodiment described above, the reinforcing portion 22f extends from the main frame portion 22a to the outer side in the left-right direction than the upper side of the supporting leg 10, but the reinforcing portion 22f may extend from the main frame portion 22a to the upper side of the supporting leg 10. Furthermore, in the embodiment described above, as long as the strength of the upper side portion of the supporting leg 10 of the main body frame 9 can be secured, the second frame 22 may not include the reinforcing portion 22f. In this case, for example, the interval between the two supporting legs 10 in the left-right direction may be narrower than the length of the main frame portion 22a in the left-right direction, and the two supporting legs 10 may be disposed on the lower side of both end portions of the main frame portion 22a in the left-right direction.

In the embodiment described above, the platen supporting portion corresponding to the platen supporting portion 25a may be integrally formed with the second frame 22. Furthermore, in the embodiment described above, the fan 23 may be attached to the upper surface of the upper surface portion 22c of the main frame portion 22a. That is, the fan 23 may be disposed in the space S. Furthermore, in the embodiment described above, the space S may not be formed between the upper surface of the main frame portion 22a and the lower surface of the platen 8.

In the embodiment described above, the Y bar 6 may be fixed only to the fixing surface 12a of the side plate 12. Furthermore, in the embodiment described above, as long as the strength of the first frame 21 can be secured, the first frame 21 may be formed only of the fixed portion 21a. Furthermore, in the embodiment described above, the second frame 22 may be configured only by the main frame portion 22a. Moreover, in the embodiment described above, the Y bar 6 may be fixed only to the two side plates 11, or may be fixed only to the two side plates 12.

In the modified example illustrated in FIGS. 12 to 14, the upper surface portion 21c may not be formed in the first frame 21. In this case, for example, the second frame 22 includes a flat plate-shaped outer side surface portion extending to the lower side from the outer side end in the front-back direction of the bottom surface portion 22d, where the outer side surface portion is fixed to the upper end portion of the side surface portion 21b of the first frame 21. Furthermore, in the modified example illustrated in FIGS. 12 to 14, the reinforcing member 45 may not be fixed to the first frame 21, and the component fixing member 46 may not be fixed to the second frame 22.

In the embodiment described above, only the outer diameter D1 of the guide roller 33 constituting the guide roller group 38 may be larger than the outer diameters D1 to D4 of the remaining seven guide rollers 33 to 36 excluding the guide roller 33. In this case, the outer diameter D1 of the guide roller 33 constituting the guide roller group 39 is equal to the outer diameters D2 to D4 of the guide rollers 34 to 36. Similarly, only the outer diameter D1 of the guide roller 33 constituting the guide roller group 39 may be larger than the outer diameters D1 to D4 of the remaining seven guide rollers 33 to 36 excluding the guide roller 33. In this case, the outer diameter D1 of the guide roller 33 constituting the guide roller group 38 is equal to the outer diameters D2 to D4 of the guide rollers 34 to 36. Even in these cases, the periodic vibration of the carriage 4 moving in the main scanning direction can be suppressed.

In the embodiment described above, the outer diameter D2 of the guide roller 34 may be equal to the outer diameter D1 of the guide roller 33, and the outer diameters D1 and D2 of the guide rollers 33 and 34 may be larger than the outer diameters D3 and D4 of the guide rollers 35 and 36. Even in this case, since the outer diameters D1 and D2 of the guide rollers 33 and 34 attached to the upper end side of the carriage main body 32 are larger than the outer diameters D3 and D4 of the guide rollers 35 and 36, the periodic vibration of the carriage 4 moving in the main scanning direction can be effectively suppressed according to the study of the inventor of the present application.

Furthermore, in the embodiment described above, the outer diameter D1 of the guide roller 33 may be equal to the outer diameters D3 and D4 of the guide rollers 35 and 36, and the outer diameter D2 of the guide roller 34 may be larger than the outer diameters D1, D3 and D4 of the guide rollers 33, 35 and 36. Even in this case, since the outer diameter D2 of the guide roller 34 attached to the upper end side of the carriage main body 32 is larger than the outer diameters D1, D3 and D4 of the remaining guide rollers 33, 35 and 36, the periodic vibration of the carriage 4 moving in the main scanning direction can be effectively suppressed according to the study of the inventor of the present application.

In the embodiment described above, the outer diameter D3 of the guide roller 35 may be larger than the outer diameters D1, D2, and D4 of the guide rollers 33, 34, and 36. Furthermore, in the embodiment described above, the outer diameter D4 of the guide roller 36 may be larger than the outer diameters D1 to D3 of the guide rollers 33 to 35.

In the embodiment described above, the carriage 4 includes two types of guide rollers 33 to 36 having different outer diameters, but the carriage 4 may include three or more types of guide rollers 33 to 36 having different outer diameters. For example, the carriage 4 may include three types of guide rollers 33 to 36 having different outer diameters. In this case, for example, the outer diameter D1 of the guide roller 33 is larger than the outer diameter D2 of the guide roller 34, and the outer diameter D2 of the guide roller 34 is larger than the outer diameters D3 and D4 of the guide rollers 35 and 36.

However, as in the embodiment described above, in a case where the carriage 4 includes two types of guide rollers 33 to 36 having different outer diameters, component management of the guide rollers 33 to 36 can be facilitated and an error in attachment of the guide rollers 33 to 36 when assembling the carriage 4 can be suppressed, as compared with a case where the carriage 4 includes three or more types of guide rollers 33 to 36 having different outer diameters.

In the embodiment described above, the guide roller groups 38 and 39 may include three guide rollers or may include five or more guide rollers. Furthermore, in the embodiment described above, the carriage 4 includes the two guide roller groups 38 and 39, but the carriage 4 may include only the guide roller group 38 or the guide roller group 39. In this case, for example, the guide roller group 38 or the guide roller group 39 is attached to the center portion of the carriage main body 32 in the left-right direction.

### REFERENCE SIGNS LIST

1 Printer (inkjet printer)
2 Medium
3 Head (inkjet head)
4 Carriage
5 Carriage driving mechanism
6 Y bar (carriage holding member)
6a Guide rail (first guide rail)
6b Guide rail (second guide rail)
6c Contact surface (first contact surface)
6d Contact surface (second contact surface)
6e Contact surface (third contact surface)
6f Contact surface (fourth contact surface)
8 Platen
8a Suction hole
9 Main body frame
10 Supporting leg
11 Side plate
12 Side plate (second side plate)
12a Fixing surface (first fixing surface)
12b Fixing surface (second fixing surface)
16 Transportation roller
19 Maintenance Unit
21 First frame
21a Fixed portion
21b Side surface portion
21c Upper surface portion
21e Second main frame portion
22 Second frame
22a Main frame portion
22d Bottom surface portion
22f Reinforcing portion
22k Platen supporting portion
23 Fan
25 Roller supporting portion
25a Platen supporting portion
32 Carriage main body
33 Guide roller (first guide roller)
34 Guide roller (second guide roller)
35 Guide roller (third guide roller)
36 Guide roller (fourth guide roller)
45 Reinforcing member
47 Platen supporting member (platen supporting portion)
D1 to D4 Outer diameter of guide roller
S Space
X First direction, sub scanning direction
X1 Front side
X2 Back side
Y Width direction of medium, main scanning direction
Z Up-down direction

1. An inkjet printer configured to perform printing on a medium by ejecting ink, the inkjet printer comprising:
an inkjet head configured to eject ink toward the medium, a platen on which the medium at the time of printing is placed, a main body frame that supports the platen from a lower side, and a plurality of supporting legs to which the main body frame is fixed at an upper end portion; wherein
when a reciprocating direction of the inkjet head is referred to as a main scanning direction, the main body frame includes a first frame having a fixed portion formed in a flat plate shape elongated in the main scanning direction and placed and fixed on the plurality of supporting legs, and a second frame having a main frame portion formed in an elongated shape elongated in the main scanning direction and formed in a groove steel shape in which both sides and a lower side in the main scanning direction are opened; and
when a direction orthogonal to an up-down direction and the main scanning direction is referred to as a first direction,
a width of the fixed portion in the first direction is wider than a width of the main frame portion in the first direction,
the main frame portion is fixed to an upper surface of the fixed portion, and
the platen is disposed on an upper side of the main frame portion.

2. The inkjet printer as set forth in claim 1, wherein the first frame includes flat plate-shaped side surface portions rising toward an upper side from both ends of the fixed portion in the first direction.

3. The inkjet printer as set forth in claim 1, further comprising:
two of the supporting legs, wherein
a length of the fixed portion in the main scanning direction is longer than a length of the main frame portion in the main scanning direction,
the two supporting legs are disposed on the outer side than the main frame portion in the main scanning direction,
the second frame includes a reinforcing portion extending from the main frame portion to at least an upper side of the supporting leg toward the outer side in the main scanning direction, and
the reinforcing portion is fixed to an upper surface of the fixed portion.

4. An inkjet printer configured to perform printing on a medium by ejecting ink from an inkjet head, the inkjet printer comprising:
a platen on which the medium at the time of printing is placed, a main body frame that supports the platen from a lower side, and a plurality of supporting legs to which the main body frame is fixed at an upper end portion; wherein
when a reciprocating direction of the inkjet head is referred to as a main scanning direction, the main body frame includes a first frame and a second frame formed in an elongated shape elongated in the main scanning direction;
when a direction orthogonal to an up-down direction and the main scanning direction is referred to as a first direction,
the second frame includes a main frame portion formed in an elongated shape elongated in the main scanning direction and formed in a groove steel shape in which both sides and a lower side in the main scanning direction are opened, and a flat plate-shaped bottom surface portion extending from a lower end of the main frame portion toward an outer side in the first direction;
the first frame includes a second main frame portion formed in an elongated shape elongated in the main scanning direction and formed in a groove steel shape in which both sides and an upper side in the main scanning direction are opened;
the second main frame portion includes a fixed portion formed in a flat plate shape elongated in the main scanning direction and placed and fixed to the plurality of supporting legs, and flat plate-shaped side surface portions rising toward an upper side from both ends in the first direction of the fixed portion;
a width of the second main frame portion in the first direction is wider than a width of the main frame portion in the first direction;
the bottom surface portion is fixed to upper end sides of the side surface portions; and
the platen is disposed on an upper side of the main frame portion.

5. The inkjet printer as set forth in claim 4, wherein
the first frame includes a flat plate-shaped upper surface portion extending from an upper end of the side surface portion toward an inner side in the first direction, and
the bottom surface portion is fixed to the upper surface portion in a state of being placed on the upper surface portion.

6. The inkjet printer as set forth in claim 4, further comprising a reinforcing member that closes an opening of the second main frame portion formed on both sides in the main scanning direction.

7. The inkjet printer as set forth in claim 1, further comprising:
a transportation roller configured to transport the medium in the first direction, and a roller supporting portion configured to rotatably support the transportation roller, wherein
the roller supporting portion is attached to the main frame portion.

8. The inkjet printer as set forth in claim 1, further comprising:
a platen supporting portion formed or fixed to the second frame and to which the platen is fixed, wherein
a plurality of suction holes for sucking the medium at the time of printing is formed in the platen,
a space to which the plurality of suction holes communicate is formed between an upper surface of the main frame portion and a lower surface of the platen, and
a fan for discharging air from the space is attached to the main frame portion.

9. The inkjet printer as set forth in claim 8, wherein the platen supporting portion is formed separately from the second frame and is fixed to the second frame.

10. The inkjet printer as set forth in claim 1, further comprising:
a carriage on which the inkjet head is mounted, a carriage driving mechanism configured to move the carriage in the main scanning direction, and a maintenance unit that prevents clogging of a plurality of nozzles formed on a lower surface of the inkjet head; wherein
a length of the first frame in the main scanning direction is longer than a length of the main frame portion in the main scanning direction; and
the maintenance unit is disposed on one side of the main frame portion in the main scanning direction, and is attached to an upper surface side of the first frame.

11. The inkjet printer as set forth in claim 1, further comprising:
a carriage on which the inkjet head is mounted, a carriage driving mechanism configured to move the carriage in the main scanning direction, a carriage holding member formed in an elongated shape elongated in the main scanning direction and configured to hold the carriage so as to be movable in the main scanning direction, two side plates that are fixed with both end portions of the carriage holding member in the main scanning direction and that are fixed to the main body frame, and two second side plates that are disposed on both sides of the main frame portion in the main scanning direction and that are fixed to the main body frame, wherein
the two second side plates are disposed on an inner side of the two side plates in the main scanning direction, and
the carriage holding member is fixed to the two side plates and the two second side plates.

12. The inkjet printer as set forth in claim 11, wherein
when one side in the first direction is referred to as a front side and the other side in the first direction is referred to as a back side,
the inkjet head mounted on the carriage is disposed on a front side of the carriage holding member,
the second side plate is formed with a first fixing surface and a second fixing surface to which the carriage holding member is fixed,
the first fixing surface is a plane orthogonal to an up-down direction,
the second fixing surface is a plane orthogonal to the first direction and is disposed on a back side and an upper side of the first fixing surface,
a front lower end portion of the carriage holding member is fixed to the first fixing surface, and
a back lower end portion of the carriage holding member is fixed to the second fixing surface.

13. The inkjet printer as set forth in claim 11, wherein
the first frame includes flat plate-shaped side surface portions rising toward an upper side from both ends of the fixed portion in the first direction; and
the second side plate is fixed to upper end sides of the two side surface portions.

14. An inkjet printer comprising an inkjet head configured to eject ink toward a medium; a carriage on which the inkjet head is mounted; a carriage driving mechanism configured to move the carriage in a main scanning direction that is a reciprocating direction of the inkjet head; and a carriage holding member formed in an elongated shape elongated in the main scanning direction and configured to hold the carriage to be movable in the main scanning direction; wherein
the carriage includes a carriage main body to which the inkjet head is attached, and a plurality of guide rollers configured to guide the carriage in the main scanning direction;
the plurality of guide rollers are rotatably attached to the carriage main body;
a guide rail, on which a contact surface with which the guide roller comes into contact is formed, is formed in the carriage holding member; and
an outer diameter of at least one guide roller among the plurality of guide rollers is different from outer diameters of the remaining guide rollers excluding the guide roller.

15. The inkjet printer as set forth in claim 14, wherein
the carriage includes a guide roller group including a plurality of the guide rollers,
when one side in a sub-scanning direction orthogonal to an up-down direction and the main scanning direction is referred to as a front side and other side in the sub-scanning direction is referred to as a back side,
the carriage main body is disposed on a front side of the carriage holding member,
the guide roller group includes a first guide roller and a second guide roller serving as the guide rollers attached to an upper end side of the carriage main body and a third guide roller and a fourth guide roller serving as the guide rollers attached to a lower end side of the carriage main body, and is attached to a back end portion of each of both end sides of the carriage main body in the main scanning direction, and
the carriage holding member is formed with a first guide rail serving as the guide rail on which a first contact surface serving as the contact surface with which the first guide roller comes into contact from the front side and a second contact surface serving as the contact surface with which the second guide roller comes into contact from an obliquely backward upper side, and a second guide rail serving as the guide rail on which a third contact surface serving as the contact surface with which the third guide roller comes into contact from the front side and a fourth contact surface serving as the contact surface with which the fourth guide roller comes into contact from an obliquely backward lower side.

16. The inkjet printer as set forth in claim 15, wherein an outer diameter of at least one of the first guide roller and the second guide roller is larger than outer diameters of the remaining guide rollers.

17. The inkjet printer as set forth in claim 14, wherein the carriage includes two types of the guide rollers having different outer diameters.
